(19) United States
(12) Patent Application Publication
(10) Pub. No.: US 2025/0094794 A1
(43) Pub. Date: Mar. 20, 2025

(54) NEUROMORPHIC COMPUTING CIRCUIT AND METHOD FOR CONTROL

(71) Applicant: Fujitsu Limited, Kawasaki-shi (JP)

(72) Inventor: Shigeyuki TAKANO, Ichikawa (JP)

(73) Assignee: Fujitsu Limited, Kawasaki-shi (JP)

(21) Appl. No.: 18/805,635

(22) Filed: Aug. 15, 2024

(30) Foreign Application Priority Data
Sep. 19, 2023 (JP) 2023-151669

(51) Int. Cl. G06N 3/063

(52) U.S. Cl. CPC G06N 3/063

(57) ABSTRACT

A neuromorphic computing circuit includes nodes including first and second nodes generating a spike including a counter for a spike existing time and a sender information, and a transmission array including transmission circuits, one or more of which is on the transmission path and forwards the spike. Each transmission circuit updates a counter value when forwarding the spike and sets, when detecting meeting of a first spike from the first to the second node and a second spike from the second to the first node, time difference based on the counter values, into the first spike. The second node includes a generation circuit specifying time difference equal or less than a first threshold among ones in the received spikes, accumulating connection strengths between the sender of third spikes set the specified differences therein and the second node, and generating a fourth spike when the accumulating result exceeds a second threshold.

### CROSS-REFERENCE TO RELATED APPLICATION

This application is based upon and claims the benefit of priority of the prior Japanese Patent application No. 2023-151669, filed on Sep. 19, 2023, the entire contents of which are incorporated herein by reference.

### FIELD

The embodiment discussed herein relates to a neuromorphic computing circuit and method for control.

### BACKGROUND

In a large-scale neural network such as natural language processing or general-purpose AI (Artificial Intelligence), numerous computations are carried out, using CPUs (Central Processing Units) or GPUs (Graphical Processing Units). When these pieces of hardware are used for machine learning, limitation to hardware expandability (scalability) and increase in consumption energy when the hardware is expanded are concerned.

Another known approach to these concerns is neuromorphic computing (hereinafter, abbreviated to NC) that mimics the function and the structure of brains.

NC is a computational model that mimics the mechanism of spike firing (fire) in a neural network (cranial neural network) formed by connecting neurons to each other via synapses, and is implemented by means of hardware (circuitry).

The spike firing means an event in which a certain neuron, when an ionic molecule flowing into the neuron from a preceding neuron exceeds a threshold, emits a high potential called spike to the preceding neuron (pre) and the certain neuron (post) via an axon serving as a transmission path of spike.

Such firing and transmission of a resultant spike activate the function of the neural network. A series of neurons in a neural network capture the feature of an input and form some meaning as a whole. A spike can be regarded as communication data in the above meaning.

As one of NC learning rules, a Spike-Timing Dependent Plasticity (hereinafter sometimes abbreviated to s STDP) model is known. The word STDP means plasticity determined by the difference between the time when a spike generated by firing in a certain neuron arrives at a synapse and the time when a spike generated by firing in another preceding neuron connected to the certain neuron arrives at the same synapse.

For example, NC operates to forward a spike fired by a neuron and cause multiple spikes to meet at a synapse. The time difference among spikes from the firing of each of the spikes and to the meeting at a synapse changes the degree (connection strength W) of connection between neurons in the synapse. The connection strength W of a synapse changes the current amount of the ion molecules (ion compound current, ion current) flowing from the synapse into a neuron, and thereby also changes the current amount for firing a spike in the neuron. That is, the transmission of a spike is affected by the connection strength W in a synapse between neurons. The connection strength W corresponds to a parameter (weight) in deep learning.

For example, related arts are disclosed in Japanese National Publication of International Patent Application No. 2022-509754, and US patent application Publication No. 2022/0309327.

### SUMMARY

According to an aspect of the embodiments, a neuromorphic computing circuit includes: a plurality of nodes that generate a spike, the spike including a counter for an existing time of the spike and information indicating a sender of the spike, the plurality of nodes including a first node and a second node; and the transmission array including a plurality of transmission circuits, one or more of the plurality of transmission circuits on the transmission path of the spike forwarding the spike. Each of the plurality of transmission circuits is configured to: update a value of the counter when forwarding the spike, set, when detecting meeting of a first spike transmitted from the first node to the second node and a second spike transmitted from the second node to the first node, a time difference calculated based on the values of the counters of the first spike and the second spike, into the first spike being forwarded. The second node includes a spike generation circuit being configured to specify one or more time differences equal or less than a first threshold among a plurality of time differences set in a plurality of spikes received from the transmission array, accumulate connection strengths each between one of the sender nodes of third spikes set the specified time differences therein and the second node, and generate a fourth spike when the result of the accumulating exceeds a second threshold.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a neuron;

FIG. 2 is a diagram illustrating an example of a formal neuron model;

FIG. 3 is a diagram illustrating an example of an STDP model;

FIG. 4 is a diagram illustrating an example of a result of measurement of a cranial nerve;

FIG. 5 is a diagram illustrating an example of calculating a time difference using a global counter;

FIG. 6 is a diagram illustrating an example of implementing a scheduler for inferring;

FIG. 7 is a diagram illustrating an example of nerve connection of neurons

FIG. 8 is a diagram illustrating an example of implementing hardware for inferring in NC;

FIG. 9 is a diagram illustrating an example of a feasible hardware scale under constraints (a)-(c);

FIG. 10 is a diagram illustrating inconvenience related to a physical distance when a formal neuron model is arranged;

FIG. 11 is a diagram illustrating an example of a network model of a NC according to one embodiment;

FIG. 12 is a block diagram illustrating an example of the configuration of neuromorphic computing hardware of the one embodiment;

FIG. 13 is a diagram illustrating an example of a data configuration of a spike of the one embodiment;

FIG. 14 is a diagram illustrating an example of a hardware configuration of a firing node;

FIG. 15 is a block diagram illustrating an example of hardware implementation of a time-difference calculating circuit and a router;

FIG. 16 is a block diagram illustrating an example of a hardware configuration of the router;

FIG. 17 is a block diagram illustrating an example of a hardware configuration of the time-difference calculating circuit;

FIG. 18 is a diagram illustrating an example of a comparator;

FIG. 19 is a flow diagram illustrating an example of a time-difference calculating process by the time-difference calculating circuit and the router of the one embodiment;

FIG. 20 is a diagram illustrating an example of transmitting a spike (time difference);

FIG. 21 is a diagram illustrating an example of transmitting a spike (time difference);

FIG. 22 is a diagram illustrating an example of transmitting a spike (time difference);

FIG. 23 is a diagram illustrating an example of transmitting a spike (time difference);

FIG. 24 is a block diagram illustrating an example of a hardware configuration of a fire mechanism;

FIG. 25 is a diagram illustrating an example of a method of calculating a target time difference;

FIG. 26 is a diagram illustrating an example of operation of the fire mechanism;

FIG. 27 is a block diagram illustrating an example of a hardware configuration of a connection strength mechanism;

FIG. 28 is a diagram illustrating an example of the configuration of the NC to be used in the description of an example of an operation of the connection strength mechanism;

FIG. 29 is a diagram illustrating an example of transmission of spikes between the multiple firing nodes in the NC and an example of an operation of the connection strength mechanism;

FIG. 30 is a diagram illustrating an example of transmission of spikes between the multiple firing nodes in the NC and an example of an operation of the connection strength mechanism;

FIG. 31 is a diagram illustrating an example of transmission of spikes between the multiple firing nodes in the NC and an example of an operation of the connection strength mechanism;

FIG. 32 is a diagram illustrating an example of transmission of spikes between the multiple firing nodes in the NC and an example of an operation of the connection strength mechanism;

FIG. 33 is a diagram illustrating an example of transmission of spikes between the multiple firing nodes in the NC and an example of an operation of the connection strength mechanism;

FIG. 34 is a diagram illustrating an example of transmission of spikes between the multiple firing nodes in the NC and an example of an operation of the connection strength mechanism;

FIG. 35 is a diagram illustrating an example of transmission of spikes between the multiple firing nodes in the NC and an example of an operation of the connection strength mechanism;

FIG. 36 is a diagram illustrating an example of transmission of spikes between the multiple firing nodes in the NC and an example of an operation of the connection strength mechanism;

FIG. 37 is a diagram illustrating an example of transmission of spikes between the multiple firing nodes in the NC and an example of an operation of the connection strength mechanism;

FIG. 38 is a diagram illustrating an example of transmission of spikes between the multiple firing nodes in the NC and an example of an operation of the connection strength mechanism;

FIG. 39 is a diagram illustrating an example of transmission of spikes between the multiple firing nodes in the NC and an example of an operation of the connection strength mechanism;

FIG. 40 is a diagram illustrating an example of transmission of spikes between the multiple firing nodes in the NC and an example of an operation of the connection strength mechanism;

FIG. 41 is a diagram illustrating an example of transmission of spikes between the multiple firing nodes in the NC and an example of an operation of the connection strength mechanism; and

FIG. 42 is a diagram illustrating an example of transmission of spikes between the multiple firing nodes in the NC and an example of an operation of the connection strength mechanism.

### DESCRIPTION OF EMBODIMENT(S)

When hardware of a NC capable of performing machine learning and reasoning is achieved (digitally implemented) by means of digital circuitry, the presence of a constraint on the hardware scalability of a NC may hinder an increase in scale of the hardware.

One of the examples of a constraint on the hardware scalability is a constraint on the maximum spike number per neuron. In calculating (time-difference calculation) the time difference among the spikes until the spike meets, the digitally-implemented STDP uses a global counter for time stamp.

However, the maximum possible number that a global counter can take is equal to the maximum number of spike occurrences. Because the size of a global counter determines the time range that can be defined, a constraint occurs on the maximum spike number per neuron that can be applied to the time-difference calculation. This may hinder the hardware scaling that increases the maximum spike number.

Hereinafter, the embodiment of the present disclosure will now be described with reference to the drawings. However, the embodiments described below are merely illustrative and there is no intention to exclude the application of various modifications and techniques that are not explicitly described in the embodiment. For example, the present embodiment can be variously modified and implemented without departing from the scope thereof. In the drawings used in the following description, the same reference numerals denote the same or similar parts unless otherwise specified.

### (A) Neuromorphic Computing Hardware:

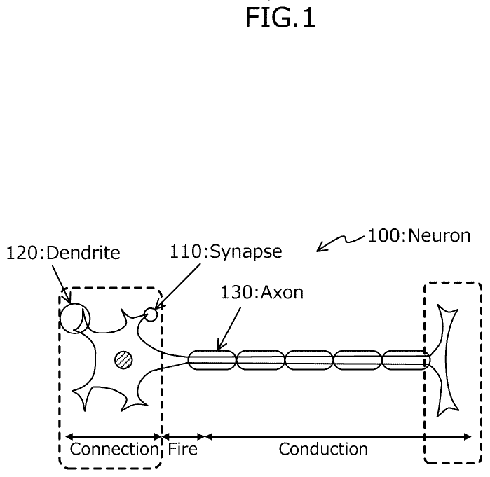

FIG. 1 is a diagram illustrating an example of a neuron 100. As illustrated in FIG. 1, the neuron includes moieties called a synapse 110, a dendrite 120, and an axon 130.

A synapse 110 is a moiety that connects neurons 100 to each other. The synapse 110 receives spike, which is formed of ion molecules (ion compound current), from the other neuron 100 (for example, preceding neuron). The amount of ionic molecular that the synapse 110 receives depends on the connection strength W at the synapse 110. The dendrite 120 is a moiety of collection of multiple synapses 110. The axon 130 is a moiety that is connected to a synapse 110 of multiple subsequent neurons 100 to serve as a spike transmission path to the connected neuron 100.

In FIG. 1, firing is an event in which, when an amount (potential) of ionic molecule flowing into the neuron 100 exceeds a threshold, emits a high potential called a spike. Transmission of a spike is affected by the connection strength W in the synapse 110 between neurons 100. The firing and the transmission of a resultant spike activate the function a neural network formed of the multiple neurons 100.

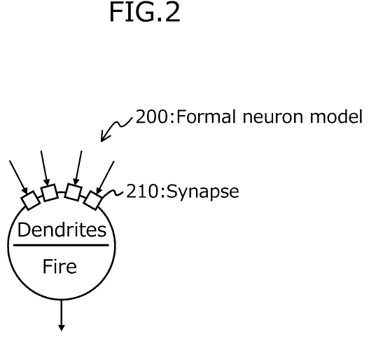

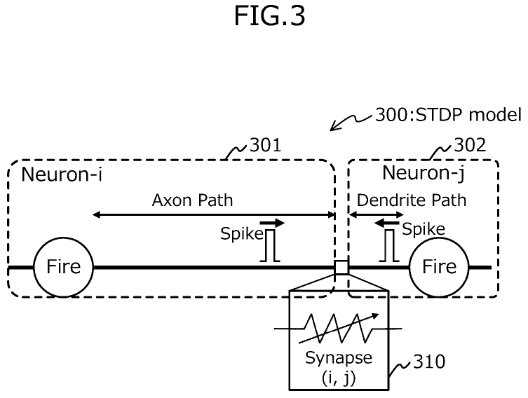

FIG. 2 is a diagram illustrating an example of a formal neuron model 200, and FIG. 3 is a diagram illustrating an example of an STDP model 300.

A formal neuron model 200 is a formal model used in expressing a neuron as a mathematical model. As illustrated in FIG. 2, the formal neuron model 200 have a function as a dendrite being a collection of the synapses 210 having a connection strength and a function of firing, and defines the connection strength of each synapse 210 in terms of the firing function.

The STDP model 300 is an example of a formal neuron model 200 and is one of learning rules based on Hebb's rule, which is a rule of cerebral synapse plasticity. Hereinafter, the NC is assumed to adopt the STDP model 300 as the learning rule.

FIG. 3 illustrates an example in which neurons 301 and 302 (denoted as “Neuron-i” and “Neuron-j”, respectively) are connected via a synapse 310 in the STDP model 300. The STDP model 300 is designed on the basis of the synapse 310 and the conditions for firing a spike in the neurons 301 and 302. As illustrated in FIG. 3, each of the neurons 301 and 302 fires and forwards the spike through the axon path or the dendrite path, and the spikes meet at the synapse 310. The STDP model 300 based on the formal neuron model 200 does not have to consider the propagation delay of a spike.

The time difference among the meeting spikes changes the connection strength W of the synapse 310. This changes the respective amounts of current flowing into the neurons 301 and 302, and also changes the amount of current for firing. Thus, for the ionic compound current flowing into the neurons 301 and 302, the connection strength W of the synapse 310 corresponds to the resistivity.

The neuron 302 fires a spike (post-spike) in response to (by using the input as a condition) a spike (pre-spike) inputted from the neuron 301 or a spike inputted from another neuron. In other words, the firing of a post-spike is correlated with the firing of a pre-spike.

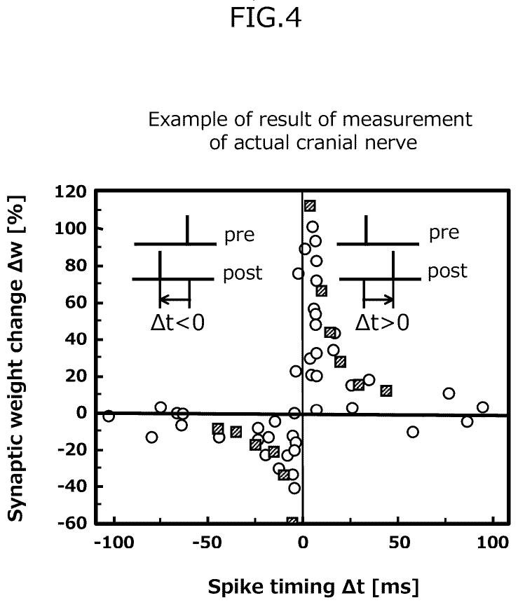

FIG. 4 is a diagram illustrating an example of a result of measurement of a cranial nerve. In the graph of FIG. 4, the abscissa represents a spike timing, that is, a difference (time difference) Δt[ms] of the arrival times of spikes, and the ordinate represents the variation amount Δw(Δt) [%] of the connection strength W. The plots of white circles and the plots of shaded squares indicate the result of measurements of respective different observers or in respective different schemes. The indication of “pre” in the graph represents a preceding neuron (e.g., the neuron 301 of FIG. 3) of the synapse 310 (see FIG. 3) and the indication of “post” represents a local neuron (e.g., the neuron 302 in FIG. 3).

The connection strength Wₜ of the synapse 310 at a certain time (timing) t is expressed by the following Expression (1).

$$Connection strength {W}_{t} = {W}_{t - 1} + Δ w ( Δ t ) \qquad ( 1 )$$

As indicated in the above Expression (1), the connection strength Wₜ varies with the time difference At between the timing of a spike arriving at the synapse 310 from the neuron 301 (pre) and the arrival timing of a spike arriving at the synapse 310 from the neuron 302 (post). This means that a change in connection strength W in the synapse 310 contributes to machine learning.

In the above Expression (1), the variation amount Δw(Δt) is represented by the following Expression (2) or (3) in accordance with the positiveness and the negativeness of Δt. The symbols A and B in the following Expression (2) and the symbols D and E in the following Expression (3) are constants.

$$variation amount Δ w ( Δ t ) = {Ae}^{B Δ t} ( Δ t > 0 ) \qquad ( 2 )$$

$$variation amount Δ w ( Δ t ) = - {De}^{E ( - Δ t )} ( Δ t < 0 ) \qquad ( 3 )$$

From the above Expressions (2) and (3), it can be grasped that, due to spike timing-dependent plasticity (STDP), a small time difference Δt abruptly changes the connection strength of the synapse 310. In the STDP model 300, machine learning is performed using the time difference Δt according to above Expression (1).

Here, the description assumes that a NC that is capable of simultaneously carrying out machine learning and inferring (e.g., capable of carrying out machine learning again after carrying out inferring) is implemented in the form of digital circuitry. Since inferring of various types can be carried out as increasing (scaling) of the scale of the NC hardware, the NC hardware is expected to be subjected to scaling as much as possible. However, the following constraints (a) to (c) exist in NC hardware scalability.
(a) The maximum value that the global counter can take equals to the maximum firing number:

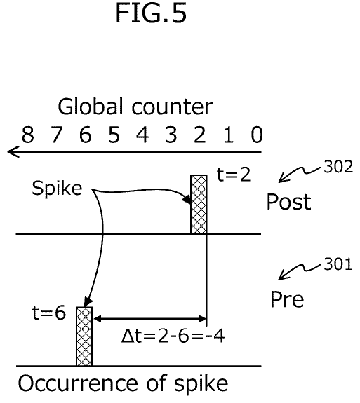

FIG. 5 is a diagram illustrating an example of calculating a time difference using a global counter. In the synapse 310 (see FIG. 3), as illustrated in FIG. 5, the time difference At between the timing (t=2) of the spike from the neuron 302 (post) and the timing (t=6) of the neuron 301 (pre) is calculated by referring to the values (0 to 8) of the global counter. In the example of FIG. 5, the time difference Δt is 2−6=−4.

From FIG. 5, the maximum number of spikes per neuron is the maximum number of global counters plus one. As the above, the maximum possible number that the global counter can take is equal to the maximum number of spike occurrences. Because the size of a global counter determines the time range that can be defined, a constraint occurs on the maximum spike number per neuron that can be applied to the time-difference calculation. This may hinder the hardware scaling that may increase the maximum spike number.
(b) The buffer size equals to the maximum spike number timing of which can be adjusted:

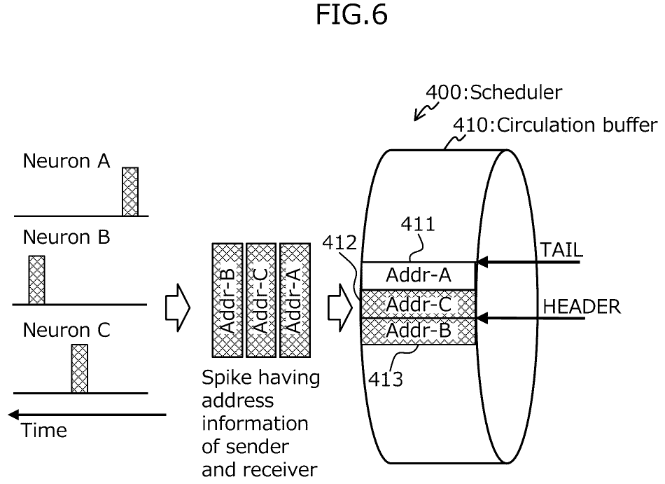

FIG. 6 is a diagram illustrating an example of implementing a scheduler 400 for inferring. As illustrated in FIG. 6, the hardware for inferring in the NC includes a scheduler 400 that adjusts the timings of spikes. An example of a scheme for adjusting the timing is AER (Address-Event Representation).

In the example of FIG. 6, spikes occur in an order of neurons A, C, and B. A spike has address information of its own receiver and sender, which information is exemplified by neuron IDs (Identifiers). In FIG. 6, the address information that the spikes outputted from the neurons A, C, and B are denoted to be “Addr-A”, “Addr-C”, and “Addr-B”, respectively.

The scheduler 400 includes a circulation buffer 410. The scheduler 400 reserves the order of spikes by inserting (storing) the spikes into the circulation buffer 410 and managing the spikes using the end pointer “TAIL” and the start pointer “HEADER”.

The scheduler 400 determines a read line to be outputted on the basis of the address information (address values). In the circulation buffer 410, slots are consumed from the address of the end pointer TAIL. FIG. 6 illustrates an example in which these spikes are stored in slots 411-413, which are storing region of circulation buffer 410, in the order of the neurons A, C, and B. In the scheduler 400, a constraint is imposed on

the maximum spike number that can be subjected to timing adjustment in accordance with the size of the circulation buffer 410. This may hinder the hardware scaling that may increase the maximum spike number.
(c) The on-chip memory cell number or the cross point number of cross bars functioning as synapse equals to the maximum connection number of a neuron.

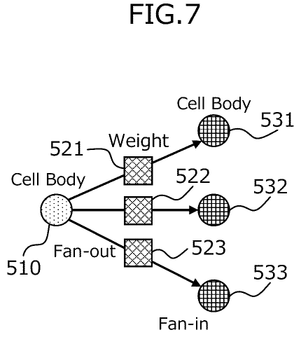

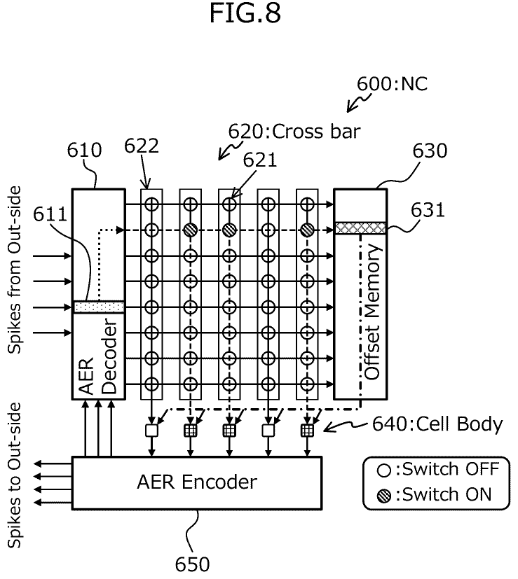

FIG. 7 is a diagram illustrating an example of nerve connection of neurons, and FIG. 8 is a diagram illustrating an example of implementing hardware for inferring NC 600.

FIG. 7 illustrates multiple cell bodies 510, 531, 532, and 533. For convenience, an individual “cell body” may be referred to as a “neuron”. It is assumed that the neuron 510 outputs a spike (Fan-out) and spike is input (Fan-in) into each of the neurons 531 to 533. FIG. 7 illustrates weights 521-523 of the synapses between neurons. The weight 521 is a connection strength W of a synapse between the neurons 510 and 531, the weight 522 is a connection strength W of a synapse between the neurons 510 and 532, and the weight 523 is a connection strength W of a synapse between the neurons 510 and 533.

FIG. 8 illustrates the NC 600 that implements the nerve connection illustrated in FIG. 7 as the hardware for inferring. In the NC 600, the aggregation of the neurons illustrated in FIG. 7 is implemented by an on-chip memory.

As illustrated in FIG. 8, NC 600 includes an AER decoder 610, a cross bar 620, an offset memory 630, multiple neurons (cell bodies) 640, and an AER Encoder (AER encoder) 650.

The cross bar 620 is a crossbar switch formed by arranging multiple switches in a matrix. The respective switches (cross points) correspond to synapses 621. Each column of multiple synapses 621 enclosed by a rectangle in FIG. 8 corresponds to a dendrite 622 provided in the neuron 640 located on the extension of the column. That is, in the NC 600, the synapses 621 and the dendrites 622 are implemented by means of the cross bar 620. The number of synapses 621 included in the cross bar 620 is the number of connectivity to the neurons 640, and is also the largest number of fan-in (inputs). In addition, the number of dendrites 622 included in the cross bar 620 is the number of neurons 640 of the receivers of spikes, and is the largest number of fan-out (outputs).

As the above, in the NC 600, the number of cross points in the cross bar 620 functioning as the synapses 621 is equal to the maximum number of connections of neurons (cell bodies) 640. This may hinder the hardware scaling that may increase the maximum connection number of neurons 640 (cell bodies).

In the NC 600 illustrated in FIG. 8, the AER decoder 610 receives a spike from the outside (the AER encoder 650 in another collection of neurons) and performs timing adjustment (see FIG. 6). The following description assumes that the spike 611 read from the AER decoder 610 is the spike from the neuron 510 in FIG. 7.

In this instance, the spike 611 propagates in cross bar 620 in the horizontal (rightward) direction of the drawing through a path indicated by a dashed line, and is tuned to the vertical (downward) direction on the drawing at the synapse 621 indicated by a shaded circle and propagates. The switching of a cross point corresponds to the switching of the switch from off to on.

The spike 611 then flows into the neuron 640 along with the weights (the weights 521-523 in FIG. 7) read from the offset memory 630 that stores the weights as a result of machine learning. The spike 611 and the weights are accumulated in the neuron 640. In FIG. 8, the shaded square neurons 640 correspond to the neurons 531 to 533 illustrated of FIG. 7.

When the neuron 640 into which the spike 611 and the weights have flown fires, a spike resultant from the firing is inputted into the AER encoder 650. The AER encoder 650 outputs the spike to the AER decoder 610 or the outside according to the receiver.

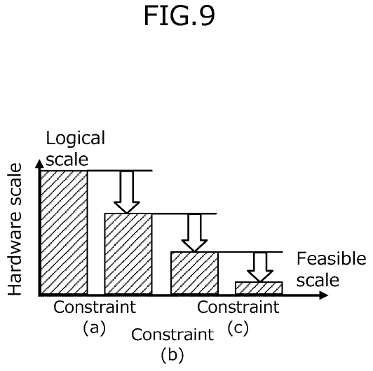

FIG. 9 is a diagram illustrating an example of a feasible hardware scale under constraints (a) to (c). As illustrated in FIG. 9, imposing of each of constraints (a) to (c) largely reduces the feasible hardware scale from the logical scale of the NC. That is, the hardware scalability of the NC is hindered by the constraints (a) to (c).

Considering the above, in one embodiment description will be made in relation to a method for improving hardware scalability of a NC. For example, in the one embodiment, by adopting a configuration that can omit the use of the global counter to the NC, at least the above-described constraint (a) can be eliminated, so that hardware scalability can be improved.

Here, using the global counter for calculating the time difference Δt contributes to solving the following inconveniences (i) to (iii) regarding the physical distance at the time of arranging the formal neuron model.
(i) The physical distance between neurons is determined by arrangement of the neurons.

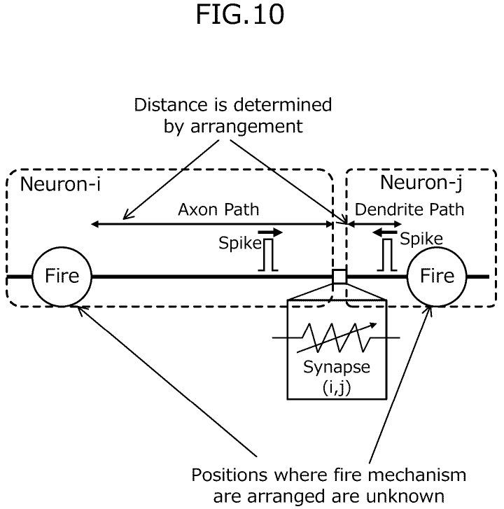

FIG. 10 is a diagram illustrating inconvenience related to a physical distance when a formal neuron model is arranged. The lengths (physical distances) of the axon path and the dendrite path in FIG. 10 are referred to as physical distances between neurons for convenience. The physical distances will depend on the location of the neurons.
(ii) The physical distance between a synapse and a neuron depends on the arrangement of the neuron (fire mechanism).

The physical distance between a synapse and a neuron depends on the arrangement of the fire mechanism. As illustrated in FIG. 10, the position where each fire mechanism (Fire) is arranged in a neuron is unknown.
(iii) The actual distance from a sender to a receiver and the time for forwarding from the sender to the receiver vary.

Therefore, if the use of the global counter for calculating the time difference Δt is to be omitted, the above-described inconveniences (i) to (iii) occur. The one embodiment describes a method for solving the above-mentioned inconveniences (i) to (iii) caused when the use of the global counter is omitted.
(B) Configuration example of one embodiment:

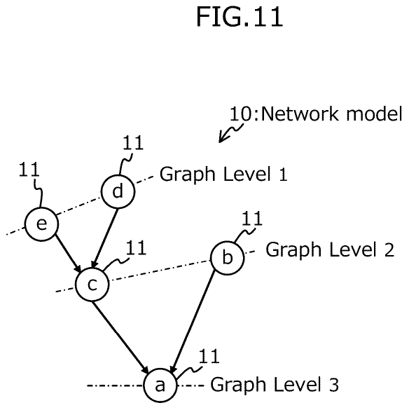

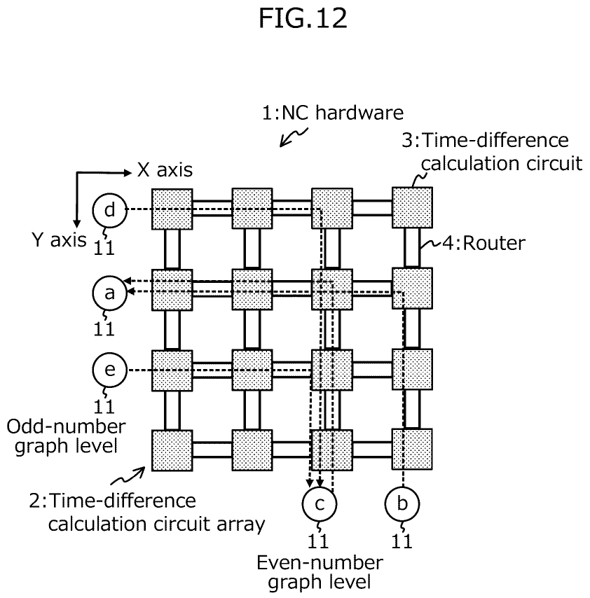

FIG. 11 is a diagram illustrating an example of a network model 10 of the NC according to one embodiment, and FIG. 12 is a block diagram illustrating an example of the configuration of neuromorphic computing hardware 1 (hereinafter sometimes simply referred to as an NC 1) of the embodiment.

As illustrated in FIG. 11, the one embodiment assumes that a network model 10 includes multiple firing nodes 11 (denoted as nodes a-e in FIG. 11). A “firing node” may be simply referred to as a “node”.

A firing node 11 is a node capable of firing a spike, and is, for example, a computation model for a cell body or a neuron. For example, a firing node 11 may operate as one or both of a transfer source and a transfer destination of a spike.

In FIG. 11, a connection between firing nodes 11 in the network model 10 is illustrated in a directed graph. A firing node 11 on the line end of an arrow in the directed graph is the forwarding source (pre) of a spike, and a firing node 11 on the pointed end of the arrow is the forwarding destination (post) of the spike.

In the network model 10, the graph levels are set in the ascending order for respective layers from the shallower layer (on the side of the line end of the arrow) of the firing node 11 to the deeper layer (on the side of the pointed end of the arrow) of the firing node 11. In Example of FIG. 11, the graph level 1 is set to the nodes d and e, the graph level 2 is set to the nodes b and c, and the graph level 3 is set to the node a.

The NC 1 illustrated in FIG. 12 is hardware implemented by arranging and wiring the network model 10 illustrated in FIG. 11. As illustrated in FIG. 12, the NC 1 may include multiple firing nodes 11 and a time-difference calculation circuit array 2.

The time-difference calculation circuit array 2 is an example of a transmission array that connects multiple firing nodes 11 to each other to form a spike transmission path. For example, the time-difference calculation circuit array 2 calculates a time difference for calculating a weight to be used in machine learning.

As illustrated in FIG. 12, the time-difference calculation circuit array 2 may include multiple time-difference calculation circuits 3 and multiple routers 4 that communicably connect time-difference calculation circuits 3 to each other. Each router 4 may be, for example, an on-chip router formed on a chip (e.g., an IC (Integrated Circuit) chip, a semiconductor chip, or a microchip) along with the time-difference calculation circuit 3.

The time-difference calculation circuit array 2 calculates the time difference Δt in a time-difference calculation circuit 3 where a pre-spike and a post-spike meet. The time difference calculation may be performed in the time-difference calculation circuit 3, but may also be performed in a firing node 11. By calculating a time difference by the time-difference calculation circuit array 2, the following (I) to (III) are achieved.
(I) A time difference calculation is enabled without using a global counter.

The time-difference calculation circuit 3 performs time-difference calculation by a method described below without using a global counter. This can eliminate the constraint (a) on the maximum number of firing of spikes.

In addition, the time-difference calculation circuit array 2 assumes a formal neuron model in which the STDP is applied as a learning rule, and therefore does not express a physical distance. The fact that the physical distance is not expressed makes it possible to freely arrange firing nodes 11.

Furthermore, the path on the time-difference calculation circuit array 2 does not handle firing time information and does not logically contain time. Instead, the path on the time-difference calculation circuit array 2 uses the timing of firing using a theoretical unit of time.
(II) The time-difference calculation accomplished by a parallel dispersed process eliminates the need for waiting (scheduler).

The time-difference calculation circuit array 2 may arrange the multiple time-difference calculation circuits 3 and the routers 4 in a two-dimensional or three-dimensional mesh-like formation, and form a transmission path according to a spike 5 by dimension order routing. The example of FIG. 12 assumes that the time-difference calculation circuit array 2 arranges multiple time-difference calculation circuits 3 and the routers 4 in a two-dimensional mesh formation and performs X-Y or Y-X routing.

In FIG. 12, if the horizontal direction of the drawing is regarded as the X-axis and the vertical direction of the drawing is regarded as the Y-axis, the nodes a, d, and e of the odd-numbered graph levels are arranged in the Y-axis direction and are respectively connected to time-difference calculation circuits 3 of time-difference calculation circuit array 2 along the X-axis direction. The even-numbered graph-level nodes b and c are arranged in the X-axis direction and are connected to the time-difference calculation circuits 3 of time-difference calculation circuit array 2 along the Y-axis direction.

For example, in the X-Y routing, spikes move in the X-axis direction from the node a, d or e of the odd-numbered graph level, then move in the Y-axis direction, and finally flow into the node b or c of the even-numbered graph level. In this way, since the transmission (propagation) path of a spike is fixed in the time-difference calculation circuit array 2, the meeting order of spikes is guaranteed. This eliminates the need for waiting by a scheduler and also eliminates the constraint (b) on the maximum spike number that can be subjected to timing adjustment.

Also, the algorithm for the X-Y or Y-X routing can avoid deadlock of spikes.

The routing scheme in the time-difference calculation circuit array 2 is not limited to the X-Y or Y-X routing, and may alternatively adopt various routing schemes.
(III) The need for a memory-cell array and a cross-point array is eliminated by arranging the function of a synapse (updating the connection strength after the time-difference calculation) in the fire mechanism.

For example, since the time-difference calculation circuit array 2 corresponds to a fully-connected network in regard of the firing nodes 11, no constraint is imposed on the Fan-in/Fan-out number. This can eliminate (e.g., abate) the constraint (c) on the maximum number of connection of neurons to synapses. For example, in the time-difference calculation circuit array 2, the time-difference calculations of the same number as the time-difference calculation circuits 3 can be carried out at the same time.

In addition, since the time-difference calculation circuit array 2 corresponds to a fully-connected network in regard of the firing nodes 11, it is possible to ensure the appearance of all spikes between the firing nodes 11. Accordingly, the combination with the above (I) can eliminate the above inconveniences (i) to (iii) while omitting the use of global counters.

As described above, the time-difference calculation circuit array 2 can solve, by the contrivance in the time-difference calculation, the constraints (a) to (c) and the inconveniences (i) to (iii) caused by the time-difference calculation.

The number of stages and another configuration of the time-difference calculation circuit array 2 may be appropriately determined in accordance with the configuration of the network model 10 used for machine learning. In the example illustrated in FIG. 12, the time-difference calculation circuit array 2 is in a 4×4 array, but when executing a large-scale inferring, the time-difference calculation circuit array 2 may increase the scale of the array (by increasing the number of stage) to increase the number of the time-difference calculation circuits 3 or may increase the number of firing nodes 11.

### (B-1) Example of Data Configuration of Spike:

Next, an example of the data configuration of a spike 5 of the one embodiment will now be described.

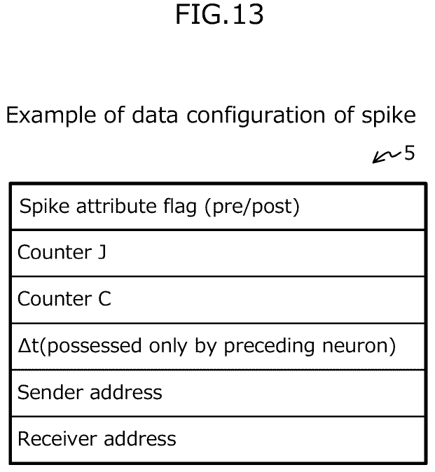

FIG. 13 is a diagram illustrating an example of a data configuration of the spike 5 of the one embodiment. As illustrated in FIG. 13, a spike 5 may include items (fields) of “spike attribute flag”, “counter J”, “counter”, “Δt”, “sender address”, and “receiver address”. These pieces of data that a spike 5 has may be each scalar data. The example of FIG. 13 assumes that the time-difference calculation circuit array 2 performs X-Y or Y-X routing.

The “spike attribute flag” is information that can distinguish whether the spike 5 is a pre-spike or a post-spike. For example, the spike attribute flag may be attached to the spike 5 at a position where the spike 5 fires (e.g., a firing node 11). A pre represents a sender and a post represents a receiver. For example, a firing node 11 on the line end of the arrow in the directed graph of FIG. 11 set a flag indicating a pre in the spike attribute flag (of the spike) when outputting spike 5. The firing node 11 on the pointed end of the arrow in the directed graph of FIG. 11 set a flag indicating a post in the spike attribute flag (of the spike) when outputting a spike 5.

Hereinafter, a spike 5 in which the flag indicating pre is set in the spike attribute flag is sometimes referred to as a “pre-spike 5”, and a spike 5 in which the flag indicating post is sometimes set in spike attribute flag is referred to as a “post-spike 5”.

A pre-spike 5 is one example of a first spike 5 transmitted from a first firing node 11 to a second firing node 11, the first and second firing nodes 11 being among the multiple firing nodes 11. A post-spike 5 is an example of a second spike 5 transmitted from the second firing node 11 to the first firing node 11.

The “counter J” is an example of meeting information indicating the presence or absence of meeting, and is a counter indicating the number of times of meeting. The initial value of the counter J is 0, which is incremented (by adding one thereto) when meeting another spike 5. Alternatively, the counter J may be replaced with various kinds of information except for the counter, for example, as far as the initial value indicates “not meeting” and a value other than the initial value indicates “already meeting”.

The “counter C” is an example of a counter for an existing time of the spike 5, and is a counter that holds information of an “existence” time. The initial value of the counter C is zero and is updated by increment (by adding one) by the clock. Alternatively, the counter C may be updated by adding a value except for one.

If the maximum time difference Δt allowed in the NC 1 is predetermined, the counter C may have an initial value corresponding to the maximum time difference Δt and may be updated by decrementing (by subtracting one) by the clock. Alternatively, in this case, the counter C may be updated by subtracting a value except for one.

The counters J and C may be updated at the time-difference calculation circuit 3 and at the sender and receiver firing nodes 11. The counters J and C may be each set in both the pre-spike 5 and the post-spike 5.

The item “Δt” a time difference calculated on the basis of the values of the counters C of a post-spike 5 and a pre-spike 5 in the time-difference calculation circuit 3 or a firing node 11 where the post-spike 5 meets the pre-spike 5 and is set to pre-spike 5 from the sender firing node 11. For example, the time difference Δt may be calculated as a difference between the value (expressed as Cₚₒₛₜ) of the counter C of the post-spike 5 and the value (expressed as Cₚᵣₑ) of the counter C of the pre-spike 5, as indicated in Expression (4).

$$Time difference Δ t = {C}_{post} - {C}_{pre} \qquad ( 4 )$$

As described above, the time-difference calculation circuit array 2 provides the pre-spike 5 with information of the time difference Δt calculated at the time-difference calculation circuit 3 where the pre-spike 5, which is to be forwarded from the sender firing node 11 to the receiver firing node 11, meets the post-spike 5, and forwards the pre-spike 5.

The “sender address” is an example of information indicating the sender of the spike 5, and is exemplified by the address of the sender firing node 11 of the spike 5. The “receiver address” is an example of information indicating the receiver of the spike 5, and is exemplified by the address of the receiver firing node 11 of the spike 5.

The above-described spike 5 is forwarded from the sender address to the receiver address by the X-Y or Y-X routing in the time-difference calculation circuit array 2. At this time, the value of the counter C of the spike 5 may be update (incremented) for each clock in the firing node 11 or the time-difference calculation circuit 3, and when the following condition is satisfied, the value of the counter C may be update or the spike 5 may be discarded.
If the value of the counter J (the number of times of meeting) after the spike 5 arrives is zero, the sender or receiver firing node 11 updates (increments) the value of the counter C.
If the value of the counter J (the number of times of meeting) after the spike 5 arrives is a value except for zero, the sender or receiver firing node 11 discards the spike 5. The value of the counter J being a value except for zero means that the spike 5 has already met another spike 5 on the path (time-difference calculation circuit 3) before reaching the sender or receiver firing node 11.
The time-difference calculation circuit 3 discards, if spikes meet at the same time-difference calculation circuit 3, a post-spike 5 from the receiver firing node 11 of the meeting spikes 5. This is because the value of the counter J of the post-spike 5 (the number of times of meeting) becomes a value except for zero.

The reason for discarding a post-spike 5 is that since the time-difference calculation circuit array 2 forwards a spike, aiming at calculating of the time difference Δt, successfully calculating Δt means that the reverse-direction post-spike 5 used for the calculation is not needed any longer.

Here, a clock may mean a time interval for which the spike 5 moves across one time-difference calculation circuit 3, in other words, a time interval for which the spike 5 takes to move between two adjoining time-difference calculation circuits 3 through the transmission path (one-hop). Since the NC 1 is a formal neuron model, the transmission path does not express a physical distance.

One or more transmission paths (paths on time-difference calculation circuit array 2) between the sender neuron of a spike 5 and the receiver neuron of the spike 5 may correspond to one synapse between the sender neuron and the receiver neuron. For example, the synapses between the firing node d and the firing node c illustrated in the directed graph in FIG. 11 are expressed by a path indicated by a dashed arrow from the firing node d to the firing node c in FIG. 12, i.e., multiple time-difference calculation circuits 3 and the routers 4 through which the spike 5 passes in the time-difference calculation circuit array 2.

### (B-2) Example of Hardware Configuration of Firing Node:

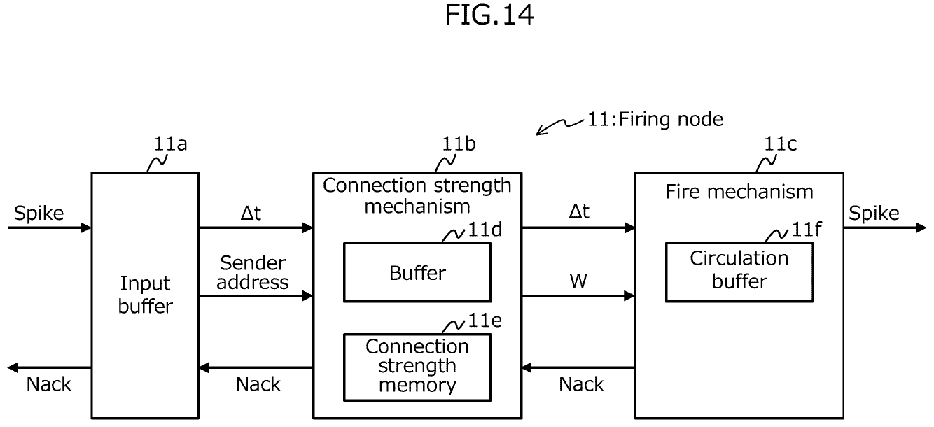

FIG. 14 is a diagram illustrating an example of a hardware configuration of a firing node 11. As illustrated in FIG. 14, the firing node 11 may include an input buffer 11a, a connection strength mechanism 11b, and fire mechanism 11c.

When the input buffer 11a receives a spike 5 in which the address of the local firing node 11 is set to the receiver address from the adjoining time-difference calculation circuit 3, the input buffer 11a outputs the time difference Δt and the sender address set in the received spike 5 to the connection strength mechanism 11b.

For example, when the value of the counter J set in the spike 5 is zero, the input buffer 11a may increment the value of the counter C set in the spike 5. In addition, the input buffer 11a may discard the spike 5 when the value of the counter J set in the spike 5 is a value except for zero.

Further, when obtaining a Nack (negative acknowledgement) from the fire mechanism 11c via the connection strength mechanism 11b, the input buffer 11a transmits (replies with) the Nack to the sender address (firing node 11) of the spike 5. A Nack is outputted, for example, when the buffer in the firing node 11 lacks, for example.

The connection strength mechanism 11b outputs the connection strength W between the firing node 11 corresponding to the sender address set in the received spike 5 and the local firing node 11 and the time difference Δt to the fire mechanism 11c. Furthermore, the connection strength mechanism 11b calculates (updates) the updated connection strength W based on the time difference Δt using the above Expression (1) on the basis of the time difference Δt, and stores the time difference Δt and the updated connection strength W.

For example, the connection strength mechanism 11b may include a buffer 11d that stores the time difference Δt and the sender address inputted from the input buffer 11a, and a connection strength memory 11e that stores the connection strength W. The connection strength mechanism 11b may read the connection strength W corresponding to the sender address from the connection strength memory 11e, and outputs the read connection strength W along with the time difference Δt to the fire mechanism 11c, and write back an updated connection strength W updated on the basis of the connection strength W and the time difference Δt into the connection strength memory 11e.

The fire mechanism 11c determines, on the basis of the time difference Δt and the connection strength W inputted from the connection strength mechanism 11b, whether or not to fire a spike 5 from the local firing node 11, and if determining to fire, transmits a spike 5.

For example, the fire mechanism 11c includes a circular buffer 11f that stores the time difference Δt and the connection strength W inputted from the connection strength mechanism 11b. The fire mechanism 11c determines whether or not to fire the spike 5 by accumulating the connection strengths W in the STDP model 300, using the circular buffer 11f.

As described above, the NC 1 according to the one embodiment can eliminate the need for a memory cell array or a cross-point array by providing the function of a synapse (updating the connection strength after calculating the time difference) in the firing node 11 (connection strength mechanism 11b).

The connection strength mechanism 11b and the fire mechanism 11c will be detailed below.

### (B-3) Example of Hardware Configuration of Time-Difference Calculation Circuit Array:

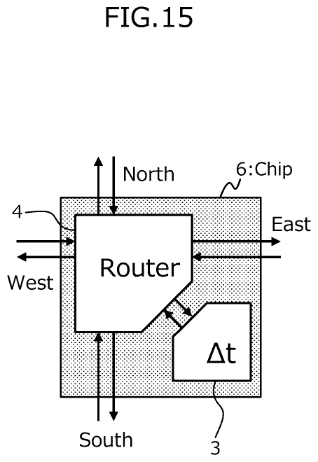

FIG. 15 is a block diagram illustrating an example of hardware implementation of a time-difference calculating circuit 3 and a router 4. As illustrated in FIG. 15, the time-difference calculation circuit 3 and the router 4 that transmits a spike 5 in the time-difference calculation circuit 3 may be implemented on a chip 6, such as an IC.

In the one embodiment, the time-difference calculation circuit array 2 assumed to carry out the X-Y or Y-X routing. The set of the time-difference calculation circuit 3 and the router 4 illustrated in FIG. 15 is one example of a single transmission circuit, and may be communicably connected to an adjoining set of the time-difference calculation circuit 3 and the router 4 by connecting the routers 4 in the respective sets to each other. For example, the router 4 may be communicably connected to at least one of the adjoining router 4 on North, South, West, and East associated with the top, the bottom, the left, and the right directions on the drawing of FIG. 12.

As described above, the time-difference calculation circuit array 2 includes multiple transmission circuits (each including the time-difference calculation circuit 3 and the router 4) that transmit a spike 5 by one or more transmission circuits on a transmission path associated with the spike 5.

Hereinafter, detailed description will now be made in relation to the time-difference calculation circuit array 2 and the firing node 11 included in the NC 1 according to the one embodiment.

### (C) Time-Difference Calculation Circuit Array:

First, the time-difference calculation circuit array 2 of the one embodiment will now be detailed.

### (C-1) Detailed Example of Time-Difference Calculation Circuit Array:

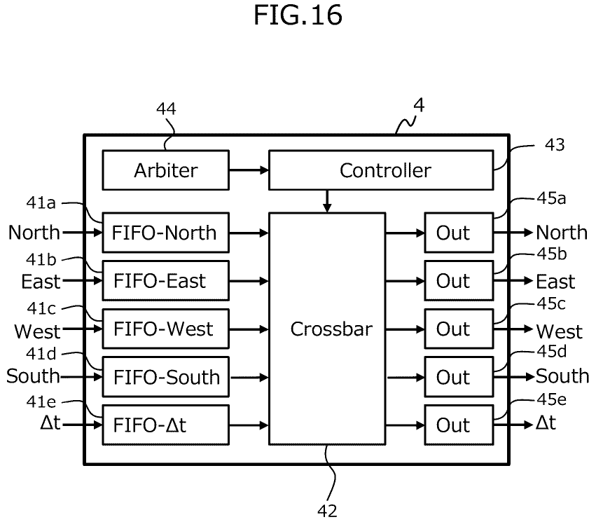

FIG. 16 is a block diagram illustrating an example of a hardware configuration of the router 4. As illustrated in FIG. 16, the router 4 may include FIFOs (First-In First-Out) 41a-41e, a cross bar 42, a controller 43, an arbiter 44, and an outputting units (Out) 45i-45e.

The FIFOs 41a-41e are each an input buffer adopting a FIFO (first-in-first-out) scheme. hereinafter, not being discriminated from one another, the FIFOs 41a-41e may be simply referred to as FIFOs 41.

The FIFOs 41a-41d each stores a spike 5 received from the adjoining routers 4 of North, East, West, or South, and outputs the spike 5 to the cross bar 42. At this time, the FIFOs 41a-41d may update (increment) the value of the counter C set in the spike 5. Alternatively, the updating of the value of the counter C may be performed in the outputting unit 45e or the time-difference calculation circuit 3 in place of the FIFOs 41a-41d.

The FIFO 41e stores a spike 5 received from the time-difference calculation circuit 3 and outputs the spike 5 to the cross bar 42.

The cross bar 42 transmits the spike 5 inputted from the FIFO41 to any one of outputting units 45a-45e under the control of a controller 43 and an arbiter 44.

The controller 43 controls switching of the path of the cross bar 42. For example, the controller 43 may switch the cross bar 42 such that the spike 5 stored in the FIFOs 41a-41d is outputted to the outputting unit 45e. Furthermore, the controller 43 may switch the cross bar 42 so that the spike 5 being received from the time-difference calculation circuit 3 and being stored in the FIFO 41e is outputted to at least one of the outputting units 45a-45d associated with the receiver address set in the spike 5.

If two or more (e.g., an even number of) spikes 5 are stored in the FIFOs 41a-41d, the controller 43 may switch the cross bar 42 such that the two or more spikes 5 are outputted to the outputting unit 45e at the same time (in the same clock). The two or more spikes 5 are, for example, a pre-spike 5 and a post-spike 5 that meet at the same time-difference calculation circuit 3.

The arbiter 44 arbitrates switching of the cross bar 42 by the controller 43 (for example, timing-adjustment).

The outputting units 45a-45d transmits a spike 5 inputted from the cross bar 42 to the adjoining routers 4 of North, East, West, South, respectively. The outputting unit 45e transmits a spike 5 inputted from the cross bar 42 to the time-difference calculation circuit 3.

As described above, the router 4 increments the value of the counter C of the spike 5 received by FIFOs 41a-41d and then outputs the spike 5 from outputting unit 45e to the time-difference calculation circuit 3. Further, the router 4 outputs a spike 5 inputted from the time-difference calculation circuit 3 from FIFO41e to a receiver outputting unit among the outputting units 45a-45d.

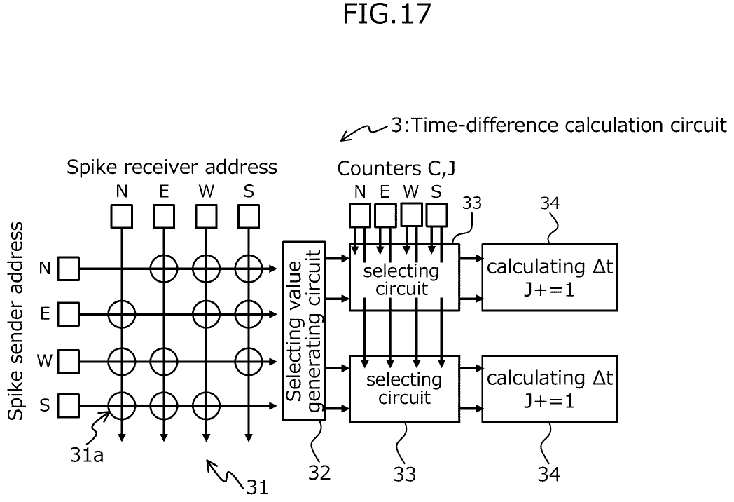

FIG. 17 is a block diagram illustrating an example of a hardware configuration of the time-difference calculating circuit 3. As illustrated in FIG. 17, the time-difference calculation circuit 3 may include a comparator array 31, a selecting value generating circuit 32, multiple (two in the example of FIG. 17) selecting circuits 33, and multiple (two in Example of FIG. 17) calculator (denoted as “calculating At” and “J+=1”) 34.

The comparator array 31 compares a sender address of one spike 5 with a receiver address of the other spike 5, which addresses are inputted into the time-difference calculation circuit 3, and when the result of comparison indicates matching, outputs the meeting information indicating that these spikes 5 meet each other to the selecting value generating circuit 32. Whether “one spike 5” or “the other spike 5” depends on a spike 5 focused on among from the pre-spike 5 and the post-spike 5. Here, the time-difference calculation circuit 3 may identify the pre-spike 5 and the post-spike 5, for example, on the basis of the spike attribute flags set in spikes 5.

The comparator array 31 may compare, for example, the sender address of the post-spike 5 and the receiver address of the pre-spike 5, or compare the sender address of the pre-spike 5 and the receiver address of the post-spike 5. Alternatively, the comparator array 31 may compare the sender address of the post-spike 5 and the receiver address of the pre-spike 5 and also compare the sender address of the pre-spike 5 and the receiver address of the post-spike 5. In the following description of the time-difference calculation circuit array 2, an example in which the sender address of the post-spike 5 is compared with the receiver address of the pre-spike 5 will be described focusing on the post-spike 5.

In the example illustrated in FIG. 17, since the time-difference calculation circuit array 2 is in a two-dimensional mesh (see FIG. 12) and the time-difference calculation circuit 3 has a four-inputs and four-outputs configuration, the comparator array 31 can deals with four spikes 5 (two pairs of a pre-spike 5 and a post-spike 5) in total.

As illustrated in FIG. 17, the comparator array 31 may include multiple (12 in the example of FIG. 17) comparators 31a. Each comparator 31a compares the sender address of a post-spike 5 with the receiver address of a pre-spike 5 among spikes 5 inputted from the FIFO 41a-41d (denoted N, E, W, and S in FIG. 17). For this purpose, the comparator array 31 crosses signal lines that transmit the respective sender addresses of the post-spikes of N, E, W, and S and signal lines that transmit the respective receiver addresses of the pre-spikes of N, E, W, and S, and arranges the comparators 31a that compare address values at the respective intersections.

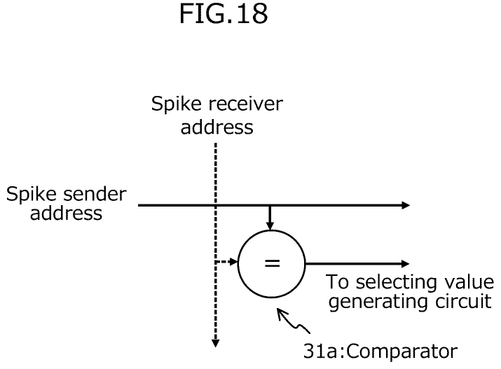

FIG. 18 is a diagram illustrating an example of a comparator 31a. As illustrated in FIG. 18, the comparator 31a compares the sender address of a spike 5 (e.g., post-spike 5) with the receiver address of a spike 5 (e.g., pre-spike 5). The addresses matching as a result of the comparison means that the post-spike 5 has met the pre-spike 5 at the time-difference calculation circuit 3. If the addresses match as a result of the comparison, the comparator 31a outputs, to selecting value generating circuit 32, pairing information (meeting information) indicating that a pair of the post spike 5 and the pre-spike 5 has met and being exemplified by information to specify two pairs of FIFOs 41a-41d associated with two signal lines compared by the comparator 31a itself.

The selecting value generating circuit 32 generates a selecting value select the counters C and J set in the post-spike 5 and the counters C and J set in the pre-spike 5 according to the pairing information notified from comparator array 31, and outputs the selecting value to selecting circuit 33. If being notified of the pair information from each of the two comparators 31a, the selecting value generating circuit 32 may output different pairing information to the respective selecting circuits 33.

On the basis of the selecting value, the selecting circuit 33 selects the counters C and J set in the post-spike 5 and the counters C and J set in the pre-spike 5, and outputs the selected counters C and J to the calculator 34.

The calculator 34 calculates the time difference Δt by calculating the difference between the counters Cₚₒₛₜ and Cₚᵣₑ obtained from the selecting circuit 33 according to the above Expression (4). The calculator 34 also increments the value of the counter J of the pre-spike 5.

The calculator 34 then outputs the pre-spike 5 updated by setting the calculated time difference Δt and the counter J having the incremented value to the router 4 (FIFO 41e).

When transmission in the spike 5 stalls, the time-difference calculation circuit 3 may add the number of stalling cycles to the counter C to calculate the time difference Δt. In other words, one or more clocks the same in amount the transmission path may be virtually reflected in the calculation of the time difference Δt. For example, the addition of the number of stalling cycles to the counter C can be implemented by counting up the counter C in every clock.

Further, as described above, the post-spike 5 that has met the pre-spike 5 at the time-difference calculation circuit 3 may be discarded the in time-difference calculation circuit 3. For example, the calculator 34 may suppress updating of the time difference Δt and the counter J of the post-spike 5 and also suppress outputting of the post-spike 5 (for example, by discarding post-spike 5).

Furthermore, if the spikes 5 do not meet at the time-difference calculation circuit 3, which is exemplified by a case where a single spike 5 that is not paired is inputted into the time-difference calculation circuit 3 at a certain clock, this spike 5 is one passing through the time-difference calculation circuit 3. The time-difference calculation circuit 3 may output a spike 5 does not meet another spike 5 to the router 4 (FIFO 41e) after the spike 5 passed the comparator array 31. In this case, the time difference Δt and the counter J of this spike 5 are not updated. The value of the counter C of this spike 5 is incremented in the FIFO 41 when the spike 5 flows into the router 4.

As described above, if detecting that the pre-spike 5 has met the post-spike 5, the time-difference calculation circuit 3 sets the time difference Δt calculated based on the values of the counters C of the pre-spike 5 and the post-spike 5 in the pre-spike 5 to be forwarded. In addition, when detecting the meeting, the time-difference calculation circuit 3 updates the counter J of the pre-spike 5 to a value different from the initial value.

The input buffer 11a included in the firing node 11 may include the configuration of the above-described time-difference calculation circuit 3. Furthermore, the router 4 having the above-described configuration may be provided between a firing node 11 and the time-difference calculation circuit 3 adjacent to the firing node 11. The input buffer 11a and the router 4 between the input buffer 11a and the time-difference calculation circuit 3 may function as the firing node 11 in the example of operation of the time-difference calculation circuit array 2 to be detailed below.

### (C-2) Example of Operation of Time-Difference Calculation Circuit Array in NC:

Next, description will now be made in relation to an example of operation of the NC 1 of the one embodiment.

### (C-2-1) Example of Operation of Time-Difference Calculating Circuit and Router:

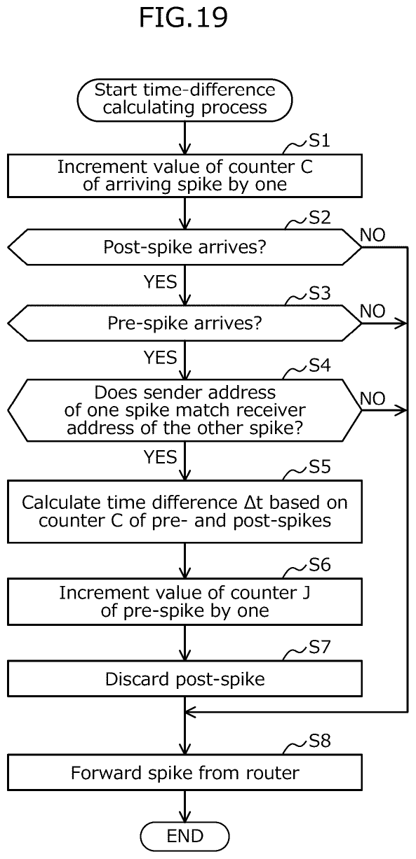

First, an example of a time difference computation algorithm in the time-difference calculation circuit 3 and the router 4 will now be described. FIG. 19 is a flow diagram illustrating an example of a time-difference calculating process performed by the time-difference calculation circuit 3 and the router 4 of the one embodiment.

As illustrated in FIG. 19, the router 4 (or the time-difference calculation circuit 3) increments the value of the counter C of an arriving spike 5 (Step S1).

When a post-spike 5 arrives at the time-difference calculation circuit 3 (YES in Step S2) and also a pre-spike 5 arrives at the time-difference calculation circuit 3 (YES in Step S3), the time-difference calculation circuit 3 determines whether the arriving spikes meet (Step S4). On the other hand, when the post-spike 5 does not arrive (NO in Step S2) or the pre-spike 5 does not arrive (NO in Step S3), the process proceeds to Step S8.

In Step S4, the time-difference calculation circuit 3 determines, by the comparator array 31, whether or not the sender address of one spike 5 matches the receiver address of the other spike 5. If the addresses do not match (NO in Step S4), the process proceeds to Step S8.

For example, when the sender address of the post-spike 5 matches the receiver address of the pre-spike 5 (YES in Step S4), the calculator 34 calculates the time difference Δt (process S5) based on the values of each of the counters C of the pre-spike 5 and the post-spike 5 and the above Expression (4).

Then, the calculator 34 increments the value of the counter J of the pre-spike 5 (Step S6). The calculator 34 discards the post-spike 5 (Step S7).

In Step S8, the router 4 forwards the updated pre-spike 5 (see Steps S5-S7) or the non-meeting spike 5 (see respective NO routes of Steps S2-S4) to the adjoining router 4, and the process ends.

### (C-2-2) Example of Transmission of Spike (Time Difference):

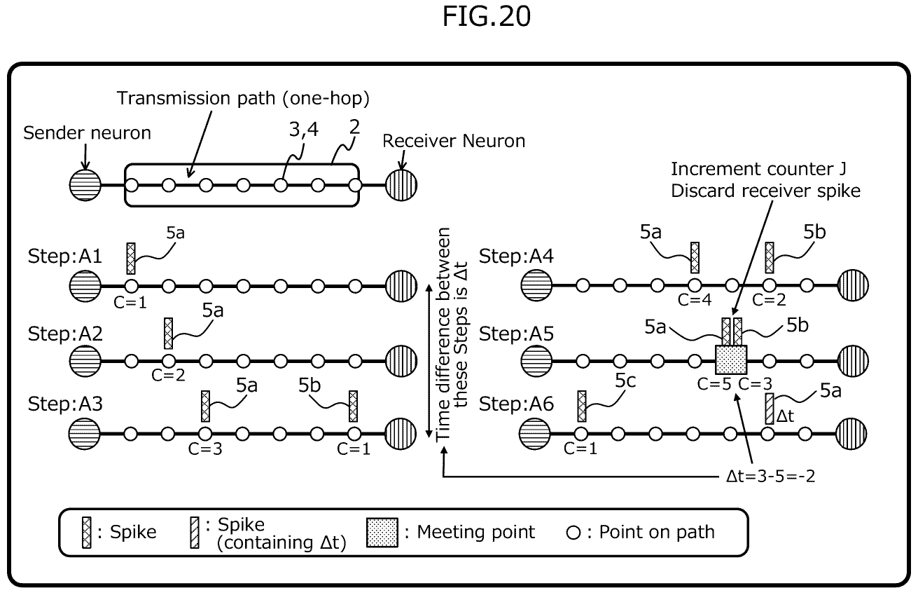

FIG. 20 to FIG. 23 are diagrams illustrating examples of transmitting a spike 5 (time difference Δt). In examples of FIG. 20 to FIG. 23, the path between the sender neuron (e.g., the first firing node 11) and the receiver neuron (e.g., the second firing node 11) is represented in one dimension. For example, as illustrated in the upper left of FIG. 20, the path between a sender neuron and a receiver neuron is formed by multiple points (a set of the time-difference calculation circuit 3 and the router 4) between firing nodes 11 in the time-difference calculation circuit array 2.

In FIG. 20 to FIG. 23, a multi-hop path (the time-difference calculation circuit array 2) between the sender neuron and receiver neuron expresses a single synapse between the sender neuron and the receiver neuron. As described above, since the NC 1 is a formal neuron model, a multi-hop path does not express a physical distance.

For convenience, in the description of FIG. 20 to FIG. 23, the set of the time-difference calculation circuit 3 and the router 4 is referred to as a “point”, and is indicated by a white circle or a shaded square. A part connecting points (between the routers 4) is referred to as a “transmission path”. In addition, the subscript numbers attached to Steps in FIG. 20 to FIG. 23 indicate states where the spike 5 starting from a step with the subscript “1” and sequentially moves forward (is transmitted) the path by one hop for each clock.

FIG. 20 illustrates an example of transmission when spikes 5 meet at a point between a sender neuron and a receiver neuron.
In Step A1, a (pre) spike 5a is sent from a sender neuron and arrives at the first left point. The value of the counter C of the spike 5a is updated to one.
In Step A2, the spike 5a arrives at the second left point. The value of the counter C of the spike 5a is updated to two.
In Step A3, the spike 5a arrives at the third left point. The value of the counter C of the spike 5a is updated to three. In addition, the (post) spike 5b is sent from a receiver neuron and arrives at the first right point. The value of the counter C of the spike 5b is updated to one.
In Step A4, the spike 5a arrives at the fourth left point. The value of the counter C of the spike 5a is updated to four. Besides, the spike 5b arrives at the second right point. The value of the counter C of the spike 5b is updated to two.
In Step A5, the spikes 5a and 5b meet at the fifth left point (i.e., the third right point). The value of the counter C of the spike 5a is updated to five. Besides, the value of the counter C of the spike 5b is updated to three. The time-difference calculation circuit 3 of this point calculates a time difference Δt(−3) by calculating a difference between the value (2) of the counter C of the post-spike 5b and the value (5) of the counter C of the pre-spike 5a, and transmits a pre-spike 5a in which the calculated time difference Δt and the counter J having the incremented value are set. In addition, the time-difference calculation circuit 3 discards the post-spike 5b.
In Step A6, the spike 5a set with the time difference Δt arrives at the sixth left point. The value of the counter C of the spike 5a does not have to be updated. Besides, a (pre) spike 5c is sent from a sender neuron and arrives at the first left point. The value of the counter C of the spike 5c is updated to one.

As described above, the time-difference calculation circuit array 2 calculates the time difference Δt between the firing timing of the post-spike 5b and the firing timing of the pre-spike 5a (i.e., in the example of FIG. 20, the time difference between Step A3 and the Step A1) in the time-difference calculation circuit 3 where these spikes 5 meet. The counters C used for calculating the time difference Δt and the calculated time difference Δt are set in the spike 5 and transmitted. Consequently, this eliminates the need for reserving a storing region such as a memory in the calculation and transmission of the time difference Δt, which can consequently be achieved by a simple configuration, a simple logic, and a scalable configuration.

The receiver neuron (e.g., the second firing node 11) updates the connection strength W between receiver neuron and the sender neuron on the basis of the time difference Δt set in the spike 5a received from the time-difference calculation circuit array 2.

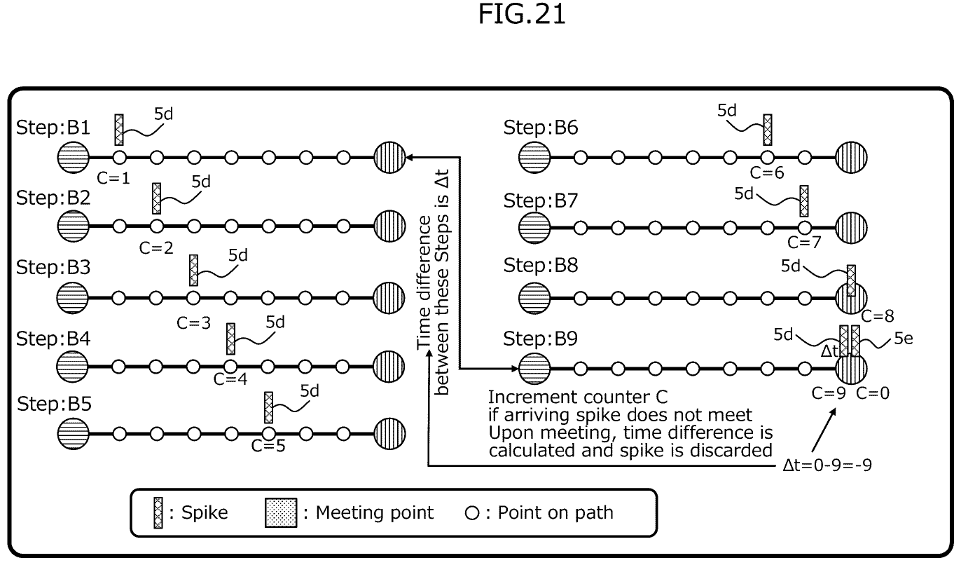

FIG. 21 illustrates an example of transmission when a pre-spike 5d from the sender neuron does not meet a post-spike 5e until the pre-spike 5a arrives at a receiver neuron (i.e., when the spike 5d meets the spike 5e at the receiver neuron).
In Step B1, a (pre) spike 5d is sent from a sender neuron and arrives at the first left point. The value of the counter C of the spike 5d is updated to one.
In each of Steps B2 to B7, as the spike 5d moves the points one by one to the right of the drawing, the value of the counter C of the spike 5d is incremented one by one.
In Step B8, the spike 5d arrives at the receiver neuron. The value of the counter C of the spike 5d is updated to eight. Since the value of the counter J of the spike 5d remains at the initial value (0), the receiver neuron holds the spike 5d.
In Step B9, the value of the counter C of the spike 5d is updated to nine. At the same time, a spike 5e is generated in the receiver neuron. In the same manner as that performed by the time-difference calculation circuit 3, the receiver neuron calculates the time difference Δt(−9) by calculating the difference between the value (0) of the counter C of the spike 5e and the value (9) of the counter C of the spike 5d in the clock that generates the spike 5e. The receiver neuron discards the spike 5d and 5e after obtaining the time difference Δt. The receiver neuron updates the connection strength W based on the obtained time difference Δt.

As the above, if the spike 5d arrives at the receiver neuron but does not meet another spike 5, the value of the counter C is incremented in each step and the spike 5d is held until meeting another spike. This enables the time-difference calculation circuit array 2 to appropriately calculate and obtain the time difference Δt between the firing timing of the post-spike 5e and the firing timing of the pre-spike 5d (the time difference between Step B9 and Step B1 in the example of FIG. 21).

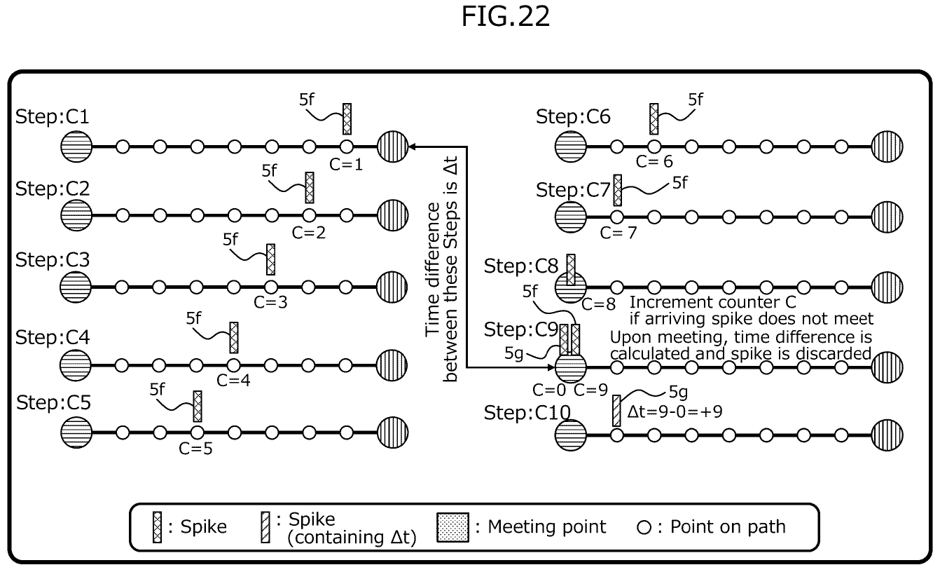

FIG. 22 illustrates an example of transmission when a post-spike 5f from the receiver neuron does not meet a pre-spike 5g until the post-spike 5f arrives at a sender neuron (i.e., when the spike 5f meets the spike 5g at the sender neuron).
In Step C1, the (post) spike 5f is sent from a receiver neuron and arrives at the first right point. The value of the counter C of the spike 5f is updated to one.
In each of Steps C2 to C7, as the spike 5d moves the points one by one to the left of the drawing, the value of the counter C of the spike 5f is incremented one by one.
In Step C8, the spike 5f arrives at the sender neuron. The value of the counter C of the spike 5f is updated to eight. Since the value of the counter J of the spike 5f remains at the initial value (0), the sender neuron holds the spike 5f.
In Step C9, the value of the counter C of the spike 5f is updated to nine. A spike 5g occurs at the sender neuron. In the same manner as that performed by the time-difference calculation circuit 3, the sender neuron calculates the time difference Δt (+9) by calculating the difference between the value (9) of the counter C of the spike 5f and the value (0) of the counter C of the spike 5g in the clock that generates the spike 5g. After calculating the time difference Δt, the sender neuron discards the post spike 5f and also transmits, to the time-difference calculation circuit array 2, an updated pre-spike 5g in which the time difference Δt and the counter J having the incremented value are set.
In Step C10, the pre-spike 5g arrives at the first left point. At this time, since the counter J of the spike 5g is one (i.e., except for zero), the router 4 and the time-difference calculation circuit 3 of this point may suppress updating of the value of the counter C of the spike 5g. At Step C10 and the subsequent steps, the pre-spike 5g proceeds one by one to the right of the drawing in each step and is discarded after arriving at the receiver neuron (after the receiver neuron obtains the time difference Δt).

As the above, if the spike 5f arrives at the sender neuron but does not meet another spike 5, the value of the counter C is incremented in each step and the spike 5f is held until meeting another spike. This enables the time-difference calculation circuit array 2 to exactly calculate and obtain the time difference Δt between the firing timing of the post-spike 5f and the firing timing of the pre-spike 5g (the time difference between Step C9 and Step C1 in the example of FIG. 22).

Whether spikes meet at a point (a time-difference calculation circuit 3 and a router 4) and on a transmission path (between routers 4) is determined by factors such as the hop number between a sender neuron and a receiver neuron, whether the value of the time difference Δt is an even number or an odd number (firing timing of each spike 5). Since the above factors depend on the routing method in the time-difference calculation circuit array 2, spikes 5 can be controlled, by the routing method, so as to meet at point (the time-difference calculation circuit 3 and the router 4).

Otherwise, the time-difference calculation circuit array 2 may be designed such that the time difference Δt can also be calculated, for example, when spikes 5 meet on a transmission path (between the routers 4).

As one example, when receiving a post-spike 5 that has not met another spike and forwarding the post-spike 5 to the adjoining point, the time-difference calculation circuit 3 may hold a duplicate of the spike 5 for at least one clock. At this time, the time-difference calculation circuit 3 may increment the value of the counter C of the duplicate of the spike 5 in accordance with the increase of one or more clocks (steps). If receiving a pre-spike 5 from the direction (N, E, W, S) in which the post-spike 5 is transmitted within a single clock since transmitting the post-spike 5, the time-difference calculation circuit 3 may determine whether the received pre-spike 5 meet the duplicate of the post spike 5 and calculate the time difference when the spikes 5 are determined to meet.

Accordingly, the time-difference calculation circuit 3 can calculate the time difference Δt even when the meeting point of the spikes 5 is on the adjoining transmission path, and can transmit the pre-spike 5, in which the time difference Δt (and the value of the counter J) is set, to the receiver neuron.

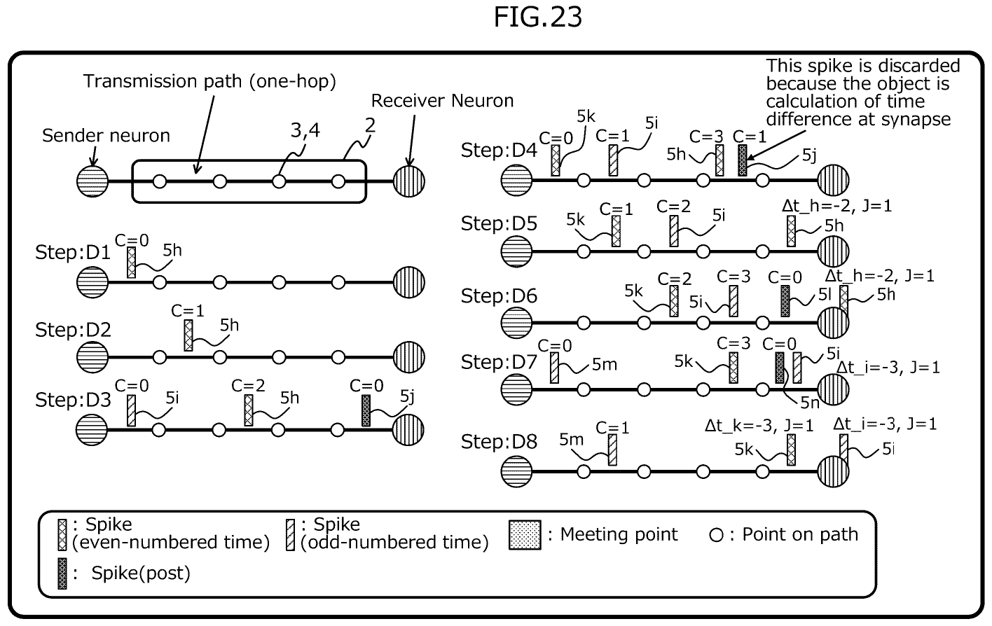

FIG. 23 illustrates an example of the operation when multiple spikes 5 are transmitted from each of the sender neuron and the receiver neuron.

In Step D1, a (pre) spike 5h is sent from the sender neuron and present on the first left transmission path. The value of the counter C of the spike 5h remains at the initial value (0).

In Step D2, the spike 5h is the present on the second left transmission path. The value of the counter C of the spike 5h has been updated to one at the first left point.

In Step D3, the spike 5h is the present on the third left transmission path. The value of counter C of the spike 5h has been updated to two at the second left point. In addition, a (pre) spike 5i is sent from the sender neuron and present on the first left transmission path. The value of the counter C of the spike 5i remains at the initial value (0). Furthermore, a (post) spike 5j is sent from receiver neuron and present on the first right transmission path. The value of the counter C of the spike 5j remains at the initial value (0).

In Step D4, the spikes 5h and 5j meet at the fourth left (second right) transmission path. The value of counter C of the spike 5h has been further updated to three at the third left point. The value of counter C of the spike 5j has been updated to one at the first right point. In addition, the spike 5i is present at the second left transmission path. Furthermore, a (pre) spike 5k is sent from the sender neuron and present on the first left transmission path. The values of the respective counters C of the spikes 5i and 5k remain at the initial value (0).

In Step D5, the pre-spike 5h is the present on the fifth left transmission path. In the spike 5h, the time difference Δt_h(−2) calculated at the fourth left point and the counter J(1) having an incremented value at the fourth left point are set. On the other hand, the post-spike 5j has been discarded.

In Step D6, the pre-spike 5h in which the time difference Δt_h is set arrives at the receiver neuron. The receiver neuron obtains the time difference Δt h, and then discards the spike 5h. In addition, the spike 5i is present at the fourth left transmission path. The value of counter C of the spike 5i has been updated to three at the third left point. Besides, the spike 5k is present at the third left transmission path. The value of counter C of the spike 5k has been further updated to two at the second left point. In addition, a spike 5l is transmitted from the receiver neuron and is present at the first right transmission path. The value of the counter C of the spike 5l remains at the initial value (0).

Between Steps D6 and D7, the spike 5i meet the spike 5l at the fourth left point (the first right point). In the pre-spike 5i, a time difference Δt_i(−3) calculated at this point and the counter J(1) having an incremented value are set. On the other hand, the post-spike 5l is discarded.

In Step D7, the pre-spike 5i in which the time difference Δt i is set is present at the fifth left transmission path. In addition, the spike 5k is present at the fourth left transmission path. The value of counter C of the spike 5k has been updated to three at the third left point. In addition, a spike 5m is sent from the sender neuron and present on the first left transmission path. In addition, a spike 5n is transmitted from receiver neuron and is present at the first right transmission path. The value of the counter C of each of the spikes 5m and 5n remains the default value (0).

Between Steps D7 and D8, the spike 5k meet the spike 5n at the fourth left point (the first right point). In the pre-spike 5k, a time difference Δt_k(−3) calculated at this point and the counter J (1) having an incremented value are set. On the other hand, the post-spike 5n is discarded.

In Step D8, the spike 5i arrives at the receiver neuron. The receiver neuron obtains the time difference Δt_h, and then discards the spike 5i. In addition, the pre-spike 5k in which the time difference Δt_k is set is present at the fifth left transmission path. The value of counter C of the spike 5k has been further updated to four at the fourth left point. In addition, the spike 5m exists on the second left transmission path. The value of counter C of the spike 5m has been updated to one at the first left point.

Also for the spikes 5h and 5j that meet on the transmission path, this enables the time-difference calculation circuit array 2 to appropriately calculate and obtain the time difference Δt between the firing timing of the post-spike 5j and the firing timing of the pre-spike 5h (the time difference between Step D3 and Step D1 in the example of FIG. 23).

### (D) Fire Mechanism of Firing Node

Next, detailed description will now be made in relation to a fire mechanism 11c (see FIG. 14) of the firing node 11 according to the one embodiment. The fire mechanism 11c is a mechanism that generates (fires, ignites) a spike 5 when the amount (potential) of ionic molecules flowing into a neuron exceeds threshold.

In a neural network, each neuron has many inputs. Accordingly, when a configuration to calculate an index corresponding to the amount of ionic molecules flowing into a neuron, such as a configuration to add the connection strength W, is implemented by a tree-structured adder circuit, the number of inputs is fixed and the scale of the adder circuit is increased, which is not feasible.

For the above, a cumulative circuit (accumulator) may be used for adding the connection strength W. However, since the NC 1 assumes a timing-based STDP, it is difficult to implement a configuration for adding (accumulating) the connection strengths W with a simple accumulating circuit.

As a solution to the above, the one embodiment describes a method for accumulating the connection strengths W in the STDP, considering the timing.

### (D-1) Example of Detailed Configuration of Fire Mechanism:

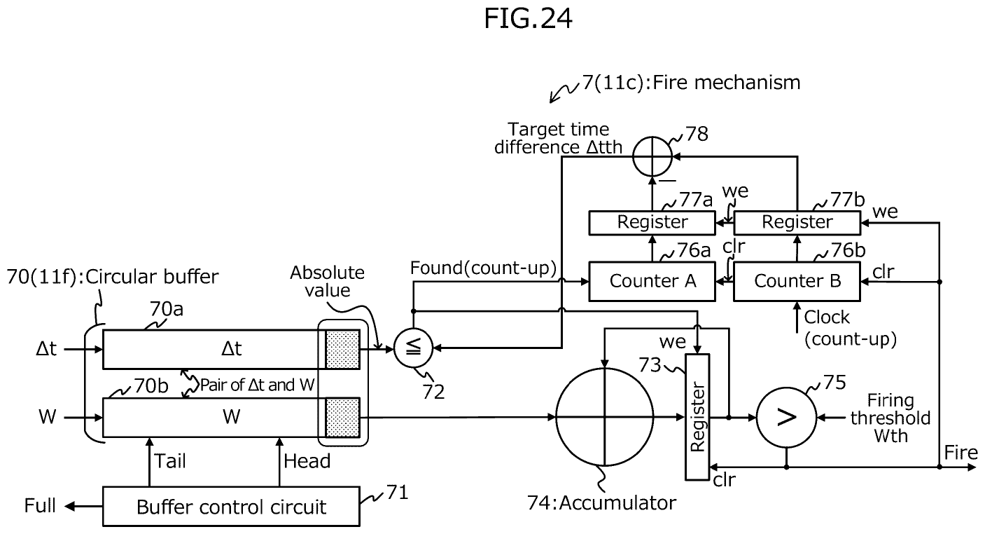

FIG. 24 is a block diagram illustrating an example of a hardware configuration of a fire mechanism 7. The fire mechanism 7 is an example of the fire mechanism 11c illustrated in FIG. 14, and is an example of a spike generation circuit.

As illustrated in FIG. 24, the fire mechanism 7 may include a circulation buffer 70, a buffer control circuit 71, comparators 72, 75, registers 73, 77a, 77b, an accumulator 74, counters 76a, 76b, and an adder 78.

The circulation buffer 70 is an example of circulation buffer 11f illustrated in FIG. 14, and is an example of a buffer that stores, for each of the multiple spikes 5 received from the time-difference calculation circuit array 2, the time difference Δt set in the spike 5 and the connection strength W between a sender firing node 11 of the spike 5 and the local firing node 11 thereof in association with each other.

The circulation buffer 70 stores, for example, a pair of the time difference Δt and the connection strength W inputted from the connection strength mechanism 11b. The circulation buffer 70 may include, for example, a circulation buffer 70a that stores the time differences At and a circulation buffer 70b that stores the connection strengths W. The time difference Δt and the connection strength W stored in pair are associated with each other by the spike 5 received by the input buffer 11a.

The buffer control circuit 71 controls the circulation buffer 70 by managing each of the circulation buffers 70a, 70b using the end pointer “Tail” and the start pointer “Head”. This ensures the order of the pairs of the time difference Δt and the connection strength W.

For example, the buffer control circuit 71 outputs a pair of the time difference Δt and the connection strength W read from the addresses of the start pointer HEADER of the circulation buffer 70a and 70b, and updates the start pointer HEADER to a value indicating the next address. For example, the time difference Δt read from the circulation buffer 70a is inputted into the comparator 72, and the connection strength W read from the circulation buffer 70b is inputted into the accumulator 74.

In addition, the buffer control circuit 71 writes the pair of the time difference Δt and the connection strength W received from connection strength mechanism 11b into the address of the end pointer TAIL of the circulation buffers 70a and 70b, and updates the end pointer TAIL to a value indicating the next address.

If the circulation buffer 70a or 70b has no available space (e.g., when TAIL=HEADER), the buffer control circuit 71 may transmit a Nack to the input buffer 11a via the connection strength mechanism 11b.

Incidentally, the above-described time-difference calculation circuit array 2 compares the sender address and the receiver address of a spike 5 for transition, meeting determination, and time-difference calculation of the spike 5. On the other hand, since the connection strengths W corresponding to (associated with) the time differences At of the spikes 5 having reached the firing node 11 is accumulated, the fire mechanism 7 does not have to distinguish the sender from the receiver of each of the spikes 5.

The comparator 72 compares the absolute value of the time difference Δt inputted from the circulation buffer 70a with the target time difference Δtth inputted from the adder 78. This means that the comparator 72 specifies a time difference Δt within a range of 0≤[time difference |Δt|]≤target time difference Δtth. For example, the comparator 72 may sequentially compare the absolute value of the time difference Δt stored in the circulation buffer 70a with the target time difference Δtth in a searching (scanning) manner.

For example, when the absolute value of the time difference Δt becomes the target time difference Δtth or less, the comparator 72 transmits Found signal (count-up signal) to the counter 76a and transmits we (write enable) signal to the register 73. The target time difference Δtth is an example of the first threshold.

In the following description, the transmission of a signal may include a change of the potential between the sender and the receiver of a signal from a first value (e.g., Low or High) indicating that the signal is invalid to a second value (e.g., High or Low) indicating that signal is valid.

As the above, the comparator 72 specifies the time difference Δt, which is the target time difference Δtth or less, among the multiple time differences At set in the multiple spikes 5 received from the time-difference calculation circuit array 2.

In response to the input of a we signal from the comparator 72, the register 73 holds the cumulative result (result of the accumulating) of the connection strengths W inputted from the accumulator 74, and outputs the held cumulative result to the comparator 75. In addition, the register 73 clears (erases) the value held therein in response to a clr (clear) signal inputted from the comparator 75.

The accumulator 74 is an example of an accumulating circuit (accumulator), and calculates an index corresponding to the amount of ionic molecules flowing into the neuron. For example, the accumulator 74 accumulates (e.g., cumulatively adds) the connection strengths W inputted from the circulation buffer 70b and the (previous) cumulative result of the connection strengths W inputted from the register 73, and outputs the cumulative result to the register 73. As described above, the cumulative result inputted into the register 73 is held in the register 73 if a we signal is inputted into the register 73. Accordingly, the register 73 holds a cumulative result of the connection strengths W, each of which is in a pair with the time difference Δt whose absolute value is the target time difference Δtth or less.

As described above, the accumulator 74 accumulates the connection strengths W between the sender (preceding) first firing node 11 of the third spike 5 in which the time difference Δt having an absolute value of the target time difference Δtth or less is set and the local (destination) second firing node 11. For example, if the time difference Δt read from the circulation buffer 70a is the target time difference Δtth or less, the accumulator 74 reads and accumulates the connection strength W stored in the circulation buffer 70b in association with the read time difference Δt from the circulation buffer 70b.

The comparator 75 compares the cumulative result inputted from the register 73 with a predetermined firing threshold Wth. The firing threshold Wth is an example of the second threshold.

For example, if the cumulative result exceeds the firing threshold Wth, the comparator 75 transmits a Fire signal indicating firing, an en signal, and a clr signal. For example, the comparator 75 may transmit the Fire signal to a circuit that transmits a spike 5 to the time-difference calculation circuit 3 (or router 4) adjacent to the local firing node 11. The circuit may be provided in the fire mechanism 7 or the firing node 11, for example. The comparator 75 may also transmit the clr signal to the register 73 and the counters 76a, 76b, for example, and also transmit the we signal to the registers 77a, 77b.

If the spike 5 fires with the cumulative result exceeding the firing threshold Wth and the subsequent search for the time difference Δt is not necessary, the comparator 75 may instruct the buffer control circuit 71 to update the end pointer TAIL.

As the above, the comparator 75 generates a new spike 5 (fourth spike 5) if the cumulative result exceeds the firing threshold Wth.

The counter 76a (sometimes referred to as “counter A”) counts the number of neurons having contributed to the firing. The counter 76a counts up the count value A and outputs the count value A to the register 77a each time a Found signal is inputted from the comparator 72, for example. In addition, the counter 76a clears (erases) the count value A held therein in response to inputting the clr signal from the comparator 75. The count value A of the counter 76a indicates logical time transition.

In other words, it can be said that the count value A indicates the number of times that the connection strengths W are accumulated in a time interval between the generation timing of the (fourth) spike 5 that has fired the latest and the generation timing of the (fifth) spike 5 that has fired immediately before the generation timing of the (fourth) spike 5. Alternatively, it can be said that the count value A indicates the number of time differences At (spikes 5) the absolute values of which are determined to be the target time difference Δtth or less by the comparator 72 in the time interval.

The counter 76b (sometimes referred to as “counter B”) counts the time interval between fires. For example, the counter 76b counts up the count value B indicating the number of steps since the previous firing in response to a clock such as the global steps, and outputs the count value B to the register 77b. In addition, the counter 76b clears (erases) the count value B held therein in response to inputting the clr signal from the comparator 75.

In other words, it can be said that the count value B indicates a time interval between the generation timing of the (fourth) spike 5 that has fired the latest and the generation timing of the (fifth) spike 5 that has fired immediately before the (fourth) generation timing of the spike 5.

In response to the input of the we signal from the comparator 75, the register 77a holds the count value A inputted from the counter 76a, and outputs the held count value A to the adder 78.

In response to the input of the we signal from the comparator 75, the register 77b holds the count value B inputted from the counter 76b, and outputs the held count value B to the adder 78.

The adder 78 updates the target time difference Δtth on the basis of the count value B inputted from the register 77b and the count value A inputted from the register 77a. For example, the adder 78 calculates the target time difference Δtth by adding the count value B and a value (negative value) obtained by inverting the sign of the count value A, and outputs the calculated target time difference Δtth to the comparator 72. That is, the target time difference Δtth may be obtained by subtracting the count value A from the count value B (calculating the difference between the count values A and B), as represented by the following Expression (5).

$$target time difference Δ tth = count value B - count value A \qquad ( 5 )$$

As described above, the counter values A and B held by the counters 76a and 76, respectively, are written to the registers 77a and 77b at the timing of the firing in the comparator 75, and are held until the timing of the next firing. Therefore, it can be said that the comparator 72 determines the time difference Δt that contributes to the current firing, using the target time difference Δtth calculated on the basis of the count values A and B at the time of the previous firing.

As can be seen from FIG. 4, a smaller time difference (time difference Δt) more increases the amount of change in the connection strength W. For the above, the fire mechanism 7 searches for a spike 5 having a time difference Δt that the time (the number of steps) required from the firing of the spike 5 to meeting of the spike between the preceding neuron and the local (destination) neuron, i.e., a spike 5 having a time difference Δt having the time interval of the firing timing of the spike 5 of a predetermined value (target time difference Δtth) or less. Then, the fire mechanism 7 accumulates the connection strengths W of only spikes 5 specified by the searching among the multiple spikes 5 flowing into the firing node 11.

This can achieve accumulation of the connection strengths W, considering the timing in the STDP, while suppressing increase in circuit scale of the fire mechanism 7 including the accumulator 74.

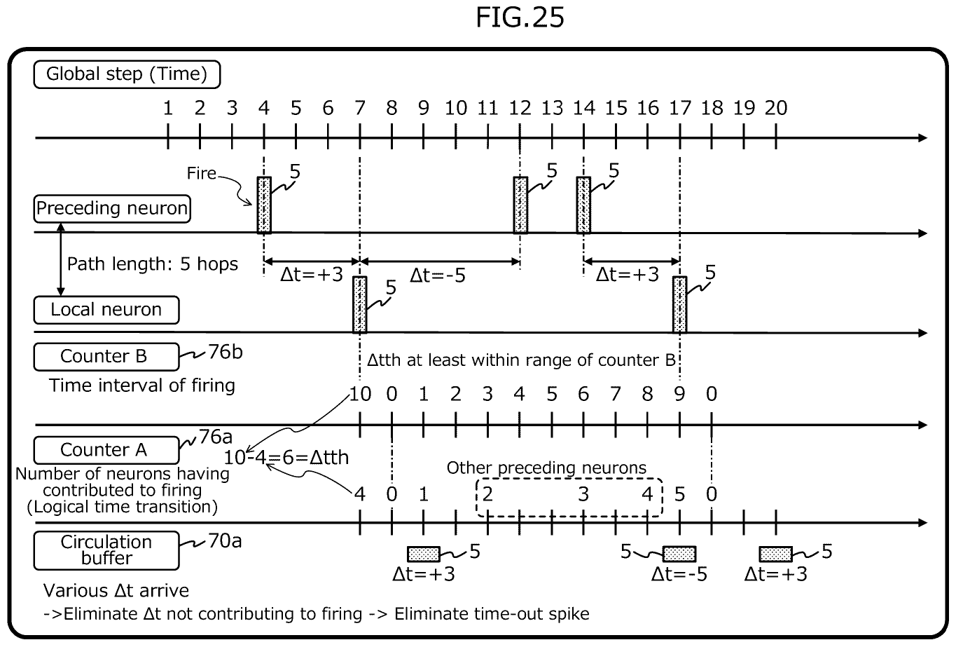

FIG. 25 is a diagram illustrating an example of a method of calculating a target time difference Δtth. As described above, although the NC 1 does not use the concept of time, the following description uses, as an index indicating a logical timing (time elapse), global steps by a global counter for convenience.

FIG. 25 illustrates each of firing timings of the spikes 5 in the preceding neuron serving as a sender of the pre-spike 5 and a destination (local) neuron serving as the sender of the post-spike 5 in association with the global steps (GS). The path length between the preceding neuron and the local neuron is assumed to be five hops.

The counter B is counted up for each GS. The counter A is counted up when receiving a spike 5 having a time difference |Δt| of the target time difference Δtth or less. In example of FIG. 25, the counter A is incremented at the GSs 9, 11, 14, 16, and 17. The counters A and B are also reset at the firing timing in the local neuron (in the example of FIG. 25, at the GSs 7 and 17).

The circulation buffer 70a receives, at the GSs 9, 17, and 20, spikes 5 with time differences Δt of +3, −5, +3, respectively, from the preceding neuron. In addition, the circulation buffer 70a receives spikes 5 from another preceding neuron at GSs 11, 14, and 16.

The target time difference Δtth is calculated as the count value B-count value A=10−4=6 at the firing timing of the local neuron in the GS 7. In the GSs 8 to 17, the target time difference Δtth=6 is used to identify the time difference Δt that contributes to firing in the comparator 72, in other words, to eliminate a time difference Δt that does not contribute to the firing. This means that by using the target time difference Δtth, a time-out spike 5 is eliminated from the circulation buffer 70.

In the GS 17, when the local neuron fires due to the accumulation of the connection strengths W of the spikes 5 having a time difference Δt=−5, the adder 78 calculates the target time difference Δtth to be used on and after the GS 18 by subtracting the count value A from the count value B, i.e., 9−5=4.

### (D-2) Example of Operation of Fire Mechanism

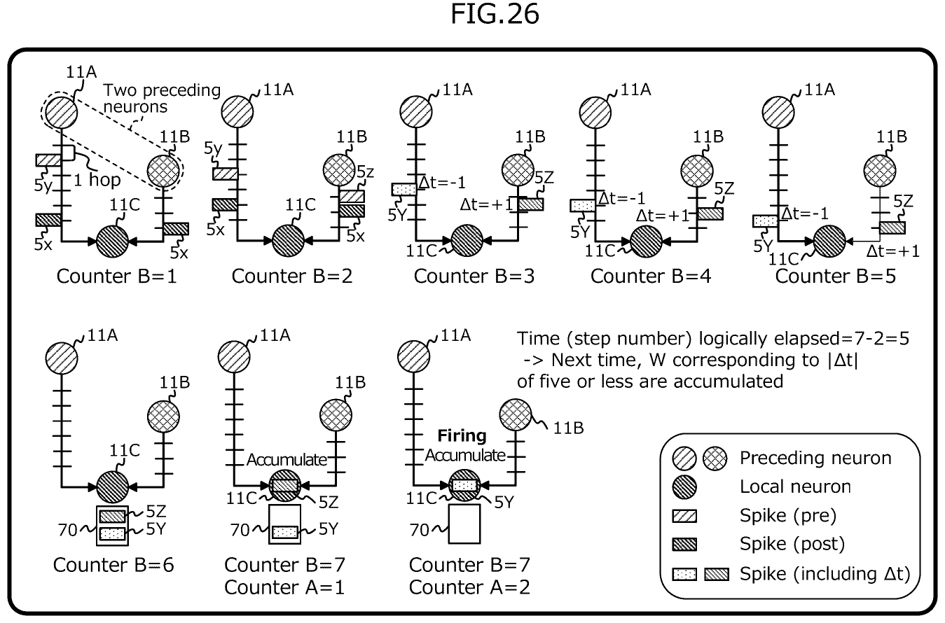

FIG. 26 is a diagram illustrating an example of the operation of the fire mechanism 7. FIG. 26 illustrates an example of a change in the state of the fire mechanism 7 in the firing node 11C of the local neuron in line with the transition (count-up) of the counter B. It is assumed that, to the local neuron, a firing node 11A of a preceding node having a hop number of five and a firing node 11B of another preceding node having a hop number of three are connected respectively.
(Before the counter B=1: out of illustration of FIG. 26)

The firing node 11C transmits a post-spike 5x to the firing nodes 11A and 11B respectively. In addition, the firing node 11A transmits a pre-spike 5y to the firing node 11C and the firing node 11B transmits a pre-spike 5 to the firing node 11C.
(When the counter B=1, 2)

The spikes 5x, 5y, and 5z proceed by one hop on the time-difference calculation circuit array 2 towards the respective receivers (destinations).
(When the counter B=3)

In the time-difference calculation circuit array 2, the spikes 5x and 5y meet, and the time difference Δt=−1 calculated in the above-described method is added to the pre-spike 5y. In addition, the spikes 5x and 5z meet, and the time difference Δt=+1 calculated in the above-described method is added to the pre-spike 5z. Furthermore, the spike 5x is discarded. Hereinafter, the spikes 5y and 5z each added with the time difference Δt are referred to as the spikes 5Y and 5Z, respectively.
(When the counter B=4, 5)

The spikes 5Y, 5Z proceed by one hop on the time-difference calculation circuit array 2 toward the firing node 11C.
(When the counter B=6)

The spikes 5Y, 5Z reach the firing node 11C, and the time difference Δt and the connection strength W of each of the spikes 5Y, 5Z are stored into the circulation buffer 70 of the fire mechanism 7. In FIG. 26, for the sake of convenience, the time differences At and the connection strengths W stored in the circulation buffer 70 are represented in rectangular frames representing the spikes 5Y, 5Z.
(When the counter B=7)

The time difference Δt included in the spike 5Z is the target time difference Δtth or less, thus the connection strength W of the spike 5Z is accumulated in the accumulator 74. The counter A is counted up from zero to one. In addition, the time difference Δt included in the spike 5Y is the target time difference Δtth or less, thus the connection strength W of the spike 5Y is accumulated in the accumulator 74. The counter A is counted up from one to two.

At this time, the output of the accumulator 74 exceeds the firing threshold Wth, and a Fire signal is transmitted from fire mechanism 7 (firing node 11C fires). The target time difference Δtth=7−2=5 is calculated as the time (the number of steps) logically elapsed from the previous firing, and the target time difference Δtth is used as a time difference range for searching for the time difference Δt of the next cumulative target. This can ignore a spike 5 having a time difference |Δt| larger than the target time difference Δtth as a time-out spike 5, which means that a step required for eliminating a spike not contributing to firing can be ignored.

### (E) Fire Mechanism of Connection Strength Mechanism

Next, detailed description will now be made in relation to a connection strength mechanism 11b (see FIG. 14) of a firing node 11 according to the one embodiment. The connection strength mechanism 11b reads the connection strength W corresponding to the sender address of the spike 5 flowing into the firing node 11 from the connection strength memory 11e, calculates an update value, and writes (writes back) the update value into the connection strength memory 11e.

Here, the connection strength W indicates a degree of connection between neurons, and therefore, is ordinary stored for each synapse site (dispersed in the connection strength memory). However, if each dispersed synapse site is provided with a connection strength W, reading and writing of a value to each site occur, so that, for example, resource for such as a network and a communication between an external memory and each connection strength memory is unnecessarily consumed to complicate the NC 1.

For the above, description will now be made in relation to an example of a method of concentratedly managing (treating) the connection strengths W in the firing node 11 by arranging the connection strength memory 11e in the connection strength mechanism 11b linked to the fire mechanism 7 in the one embodiment.

### (E-1) Detailed Example of Configuration of Fire Mechanism

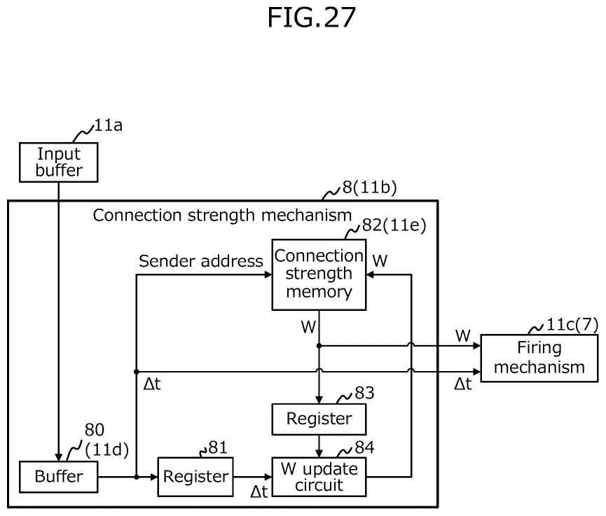

FIG. 27 is a block diagram illustrating an example of the hardware configuration of the connection strength mechanism 8. The connection strength mechanism 8 is an example of the connection strength mechanism 11b illustrated in FIG. 14.

The connection strength mechanism 8 is an example of a connection strength updating circuit that updates a first connection strength W between local (destination) firing node 11 and the preceding (sender of a spike 5) firing node 11 on the basis of the time difference Δt set in the same spike 5 received from the time-difference calculation circuit array 2.

The connection strength mechanism 8 may include a buffer 80, registers 81, 83, the connection strength memory 82, and a W update circuit 84, as illustrated in FIG. 27.

The buffer 80 is an example of the buffer 11d illustrated in FIG. 14, and stores information of a spike 5 inputted from input buffer 11a, for example, at least a time differences Δt and a sender address included in a spike 5. The buffer 80 outputs the time difference Δt to the register 81 and the fire mechanism 11c (e.g., fire mechanism 7) respectively and also outputs the sender address to the connection strength memory 82.

The register 81 stores the time difference Δt inputted from the buffer 80 and outputs the time difference Δt to the W update circuit 84.

The connection strength memory 82 is an example of a memory that stores information indicating each of multiple firing nodes 11 and a connection strength W between each of the firing node 11 and the local node firing node 11 in association with each other. The connection strength memory 82 may be achieved by, for example, a storing region that stores the connection strength W associated with the sender address.

For example, the connection strength mechanism 8 searches the connection strength memory 82, using a sender address inputted from the buffer 80 as a key, reads the connection strength W associated with the sender address from the connection strength memory 82, and outputs the read connection strength W to the register 83 and the fire mechanism 11c (e.g., fire mechanism 7).

Alternatively, the connection strength mechanism 8 may search connection strength memory 82 for the connection strength W by using a mapping table that associates the sender address with an address in the connection strength memory 82. The mapping table may be, for example, a table in which the hash values of one or both of the sender address and an address in the connection strength memory 82 associated with each other.

The register 83 stores the connection strength W inputted from the connection strength memory 82 and outputs the connection strength W to the W update circuit 84.

The W update circuit 84 calculates the updated connection strength W based on the time difference Δt inputted from the register 81 and the connection strength W inputted from the register 83. In addition, the W update circuit 84 also updates the connection strength W stored in the connection strength memory 82 in association with the sender address by writing (writing back) the calculated connection strength W into the connection strength memory 82 in association with the sender address. As a method of updating the connection strength W by the W update circuit 84, various methods may be used.

For example, the W update circuit 84 may calculate the connection strength Wₜ, using the following Expression (6) which is the same as the above Expression (1). In the following Expression (6), Wₜ₋₁ represents the connection strength W inputted from the register 83, and Δw(Δt) represents the amount of the variation of the connection strength W calculated on the basis of the time difference Δt inputted from the register 81.

$$Connection strength {W}_{t} = {W}_{t - 1} + Δ w ( Δ t ) \qquad ( 6 )$$

As the above, the connection strength mechanism 8 and the W update circuit 84 is an example of an update circuit that reads a first connection strength W from the connection strength memory 82 on the basis of the sender address included in a spike 5 received from time-difference calculation circuit array 2 and updates the first connection strength W stored in the connection strength memory 82 on the basis of the time difference Δt set in the spike 5 and the read first connection strength W.

As described above, the connection strength mechanism 8 according to the one embodiment can concentratedly manage and update the connection strength W for each sender address, using the connection strength memory 82, and can transmit an appropriate pair of the time difference Δt and the connection strength W to the subsequent fire mechanism 7. This can achieve both simplification of the circuit configuration of the NC 1 (firing node 11) and suppression of resource consumption in scheduling and networks, for example.

### (E-2) Example of Operation of Connection Strength Mechanism:

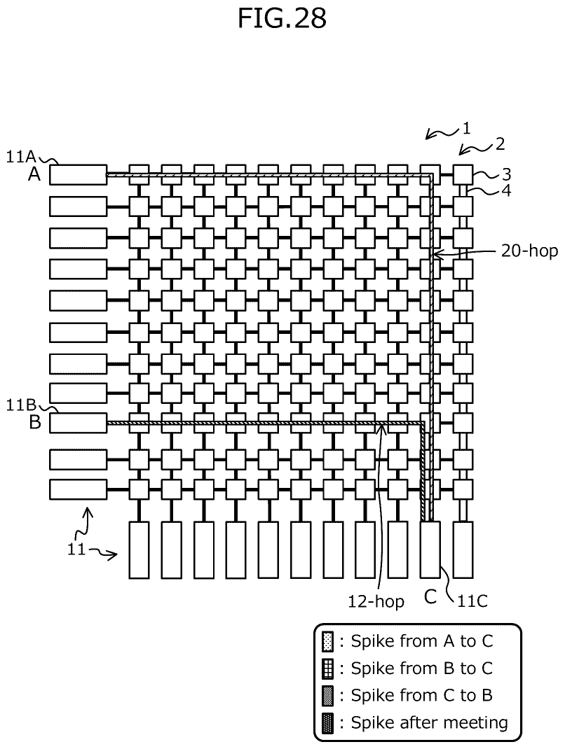

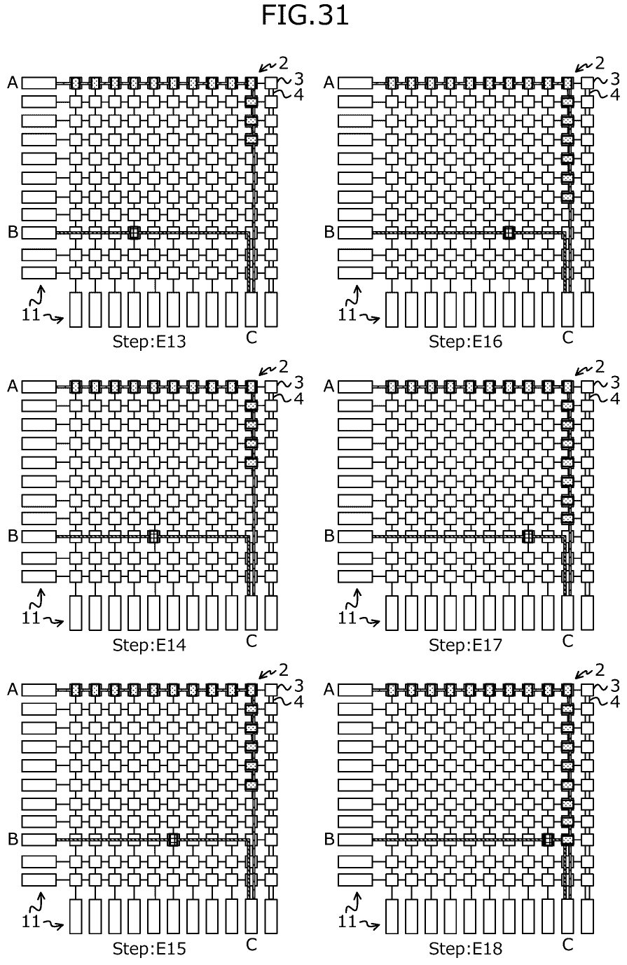

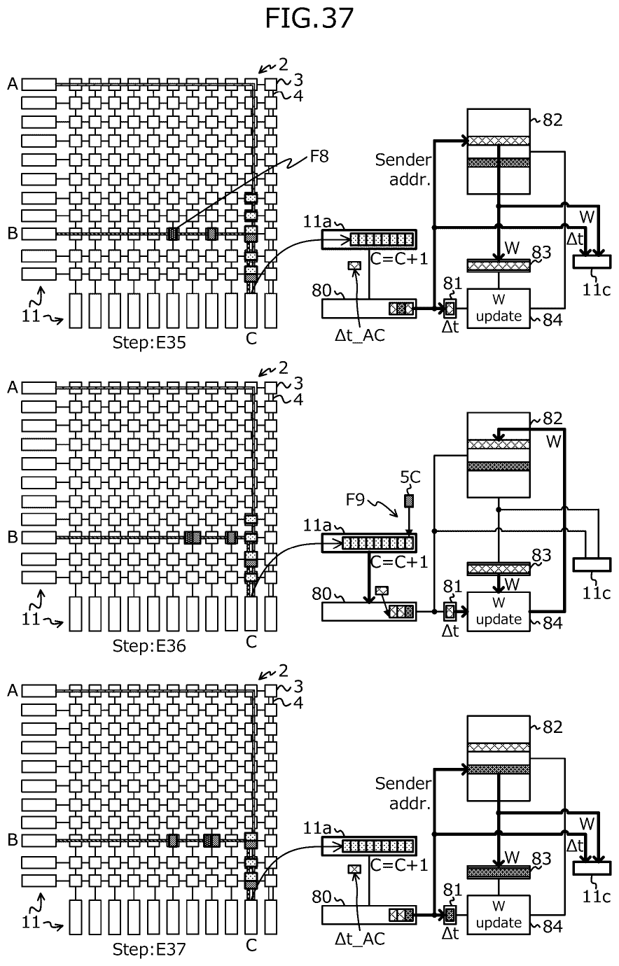

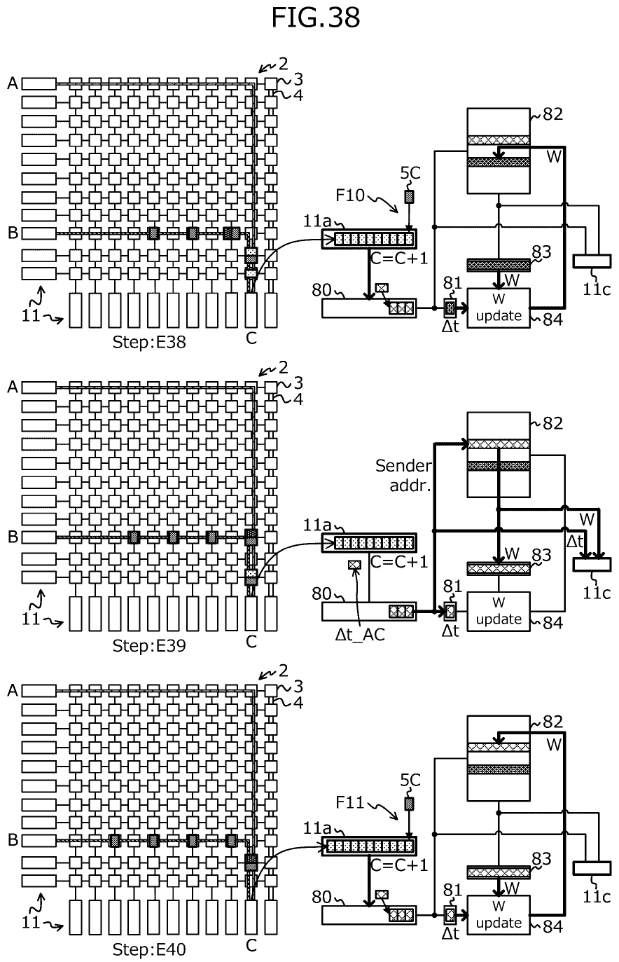

Next, description will now be made in relation to an example of the operation of the connection strength mechanism 8 according to the one embodiment with reference to FIG. 28 to FIG. 42.

FIG. 28 is a diagram illustrating an example of the configuration of the NC 1 to be used in the description of an example of an operation of the connection strength mechanism 8. FIG. 28 illustrates multiple firing nodes 11 and the time-difference calculation circuit array 2 including multiple time-difference calculation circuits 3 and multiple routers 4. In the following description, among the multiple firing nodes 11, firing nodes 11A, 11B and 11C attached with reference signs A-C, respectively, will now be focused. In addition, in the following description, the connection strength mechanism 8, the input buffer 11a, and the fire mechanism 11c (for example, fire mechanism 7) included in the firing node 11C will be focused.

A transmission path of a spike 5 between firing nodes 11 has a fixed path length determined according to the arrangement of the firing nodes 11. For example, it is assumed that the path length between the firing node 11A and the firing node 11C is 20 hops and the path length between the firing node 11B and the firing node 11C is 12 hops.

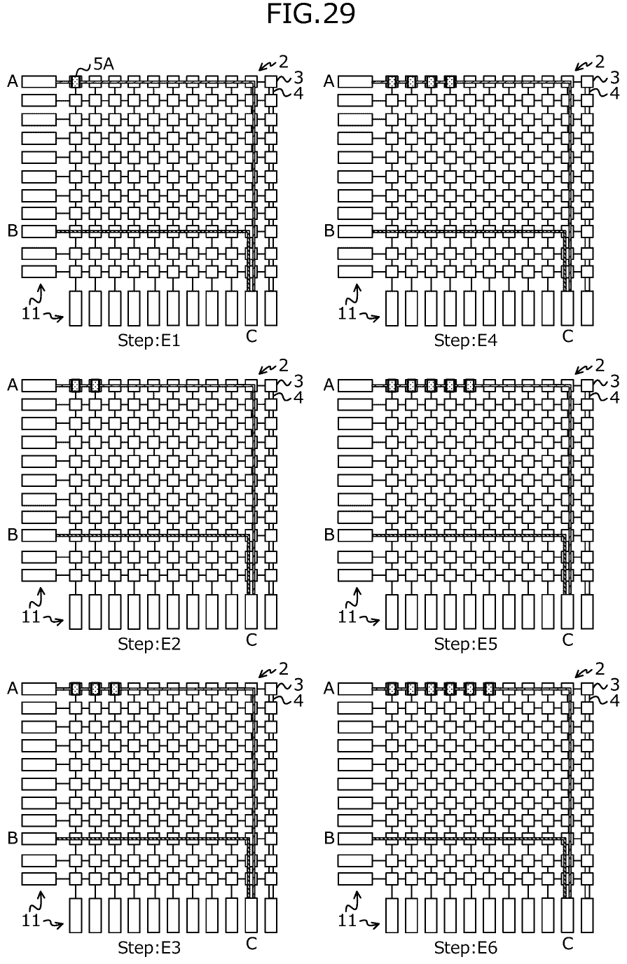

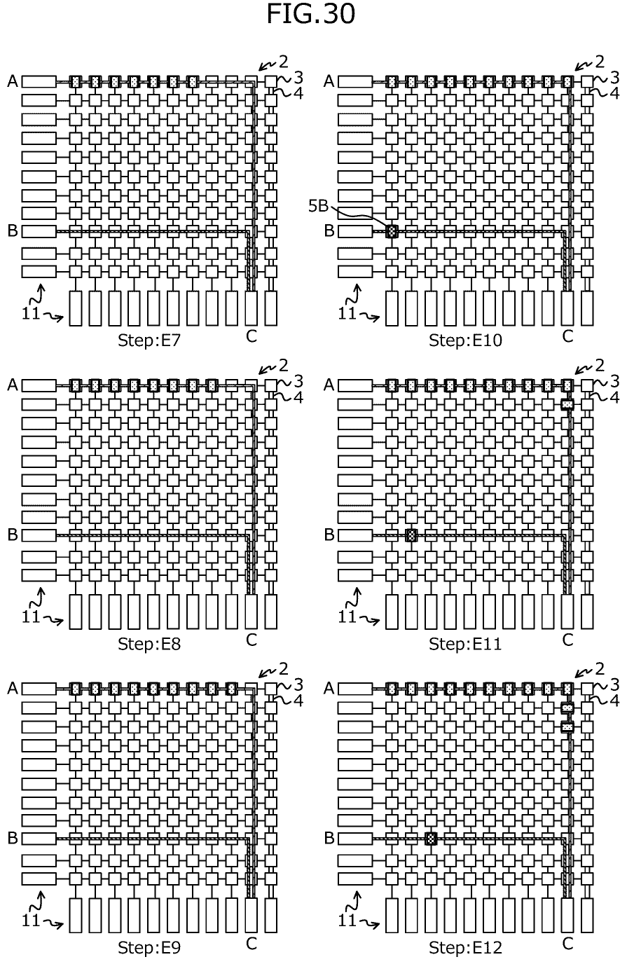

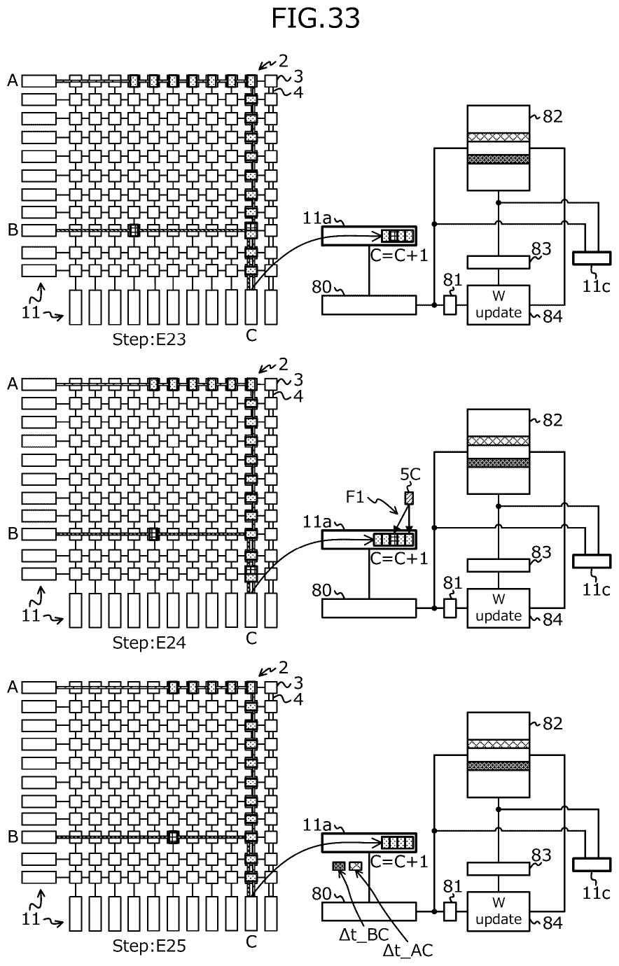

In the following description, the firing node 11A transmits 20 pre-spikes 5A (see FIG. 29, for example) destined for the firing node 11C in succession (one for each of the 20 steps). The firing node 11B transmits pre-spikes 5B (see FIG. 30, for example) destined for the firing node 11C at predetermined intervals (one for every several steps). The firing node 11C transmits post-spikes 5C (see FIG. 33, for example) destined for the firing node 11B at a predetermined timing.

FIG. 29 to FIG. 42 are diagrams illustrating examples of transmission of spikes 5 between the multiple firing nodes 11 in the NC 1 and examples of operations of the connection strength mechanism 8. Hereinafter, description will now be made in relation to an example of an operation of the connection strength mechanism 8, detailing an example of each step of transmission of the spikes 5 between the firing nodes 11A, 11B, and 11C, with reference to FIG. 29 to FIG. 42.

Here, each of the steps E1 to E63 illustrated in FIG. 29 to FIG. 42 indicate logical time transitions, but do not indicate the passage of time.

### (Steps E1 to E9)

As illustrated in FIG. 29 and FIG. 30, the firing node 11A transmits spikes 5A to the firing node 11C in succession in Steps E1-E9. In each step, the spikes 5 are transmitted by one hop along the transmission path on the time-difference calculation circuit array 2. The same applies to the following description.

### (Step E10)

As illustrated in FIG. 30, the firing node 11B transmits a spike 5B to the firing node 11C in Step E10. The firing node 11A continues to transmit spikes 5A to the firing node 11C in succession.

### (Steps E11 to E19)

As illustrated in FIG. 30 to FIG. 32, the firing node 11A transmits spikes 5A to the firing node 11C in succession in Steps E11-E19.

### (Step E20)

The firing node 11B transmits a spike 5B to the firing node 11C in Step E20. The firing node 11A continues to transmit spikes 5A to the firing node 11C in succession.

### (Steps E21 to E23)

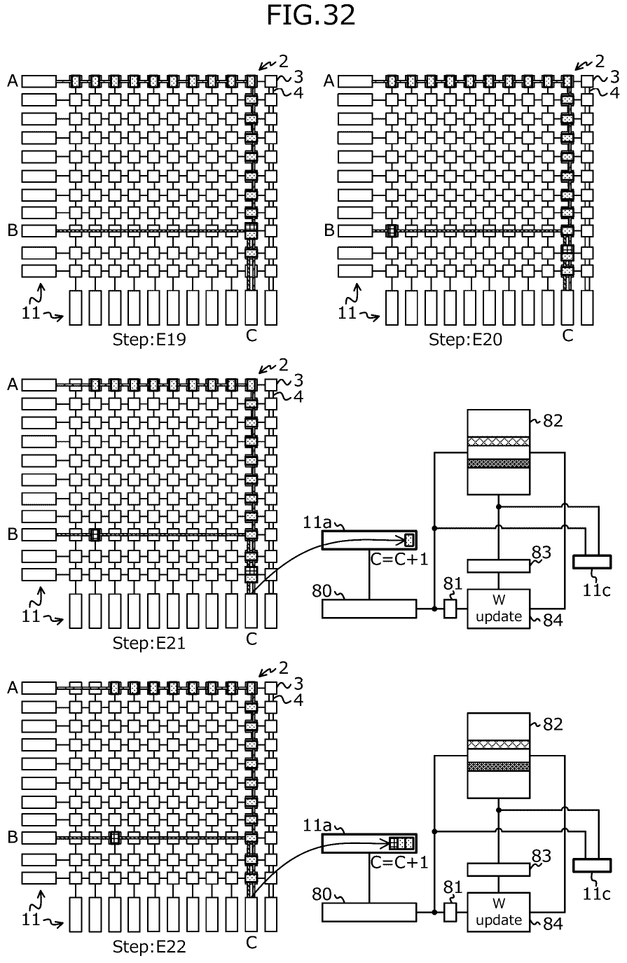

As illustrated in FIG. 32 and FIG. 33, in Step E21, the spike 5A transmitted from the firing node 11A reaches the firing node 11C and is stored into the input buffer 11a. In this step, transmission of the spike 5A from the firing node 11A is stopped. In Step E22, the spike 5A transmitted from the firing node 11A and the spike 5B transmitted from the firing node 11B reach the firing node 11C and are stored into the input buffer 11a. In Step E23, the spike 5A transmitted from the firing node 11A reaches the firing node 11C and is stored into the input buffer 11a.

The value of the counter C of the spike 5 stored in the input buffer 11a is incremented by one in each step until the spike 5 stored in the input buffer 11a of the firing node 11C meets the spike 5 transmitted from the firing node 11C (expressed as “C=C+1”).

The following description may sometimes omit the transmission of spikes 5 from the firing nodes 11A and 11B, the reception of a spike 5 in the firing node 11C, the storing of a spike 5 into the input buffer 11a, and the updating of the counter C in the input buffer 11a.

### (Step E24)

In Step E24, the fire mechanism 11c of the firing node 11C generates a post spike 5C destined for the firing node 11B. The spike 5C meets each of the spike 5A and 5B stored the earliest for each firing node 11 of the sender firing node 11 among spikes 5 stored in input buffer 11a (see the reference sign F1).

The logic of the meeting of spikes 5 is the same as that of the time-difference calculation circuit array 2 described above. For the purpose of calculating the connection strength W for each firing node 11 in the connection strength mechanism 8, one post-spike 5C meets each of multiple (two in FIG. 33) pre-spikes 5A, 5B in the input buffer 11a, as illustrated in Step E24. In addition, in the example of Step E24, the spike 5C meets the spike 5B from firing node 11B, which is the receiver of the spike 5C, and therefore may be discarded in the firing node 11C. Since each spike 5 has information of the sender (firing source) address and the receiver address (see FIG. 13), the firing node 11C can easily detect that the spike 5C has met the spike 5B. For example, the input buffer 11a of the firing node 11C may compare the sender addresses set in each of the pre-spikes 5A and 5B with the receiver address set in the post-spike 5C and, if the result of the comparison indicates matching of the addresses, discard the post-spike 5C.

### (Step E25)

In Step E25, the input buffer 11a obtains, due to the meeting of the spikes 5 in Step E24, the time difference Δt_AC between the spikes 5A and 5C and the time difference Δt_BC between the spikes 5B and 5C. In addition, the respective sender addresses of the spikes 5A and 5B are obtained.

### (Step of E26)

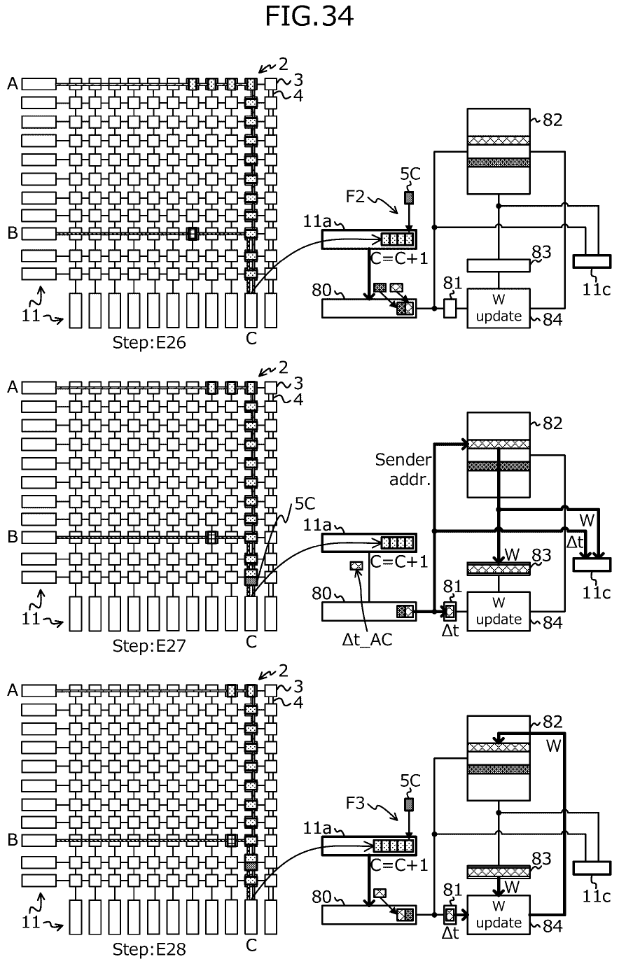

As illustrated in FIG. 34, in Step E26, the fire mechanism 11c of the firing node 11C generates a post spike 5C destined for the firing node 11B. The spike 5C meets spike 5A stored the earliest among the spikes 5 stored in the input buffer 11a (see the reference sign F2). In addition, the time differences At AC and At BC obtained in Step E25 and the sender addresses are stored in the buffer 80 of the connection strength mechanism 8.

### (Step E27)

In step E27, the spike 5C generated in Step E26 is transmitted from the firing node 11C to the time-difference calculation circuit array 2. The input buffer 11a obtains, due to the meeting of the spikes 5 in Step E26, the time difference Δt AC between the spikes 5A and 5C and the sender address of the spike 5A.

In the connection strength mechanism 8, the time difference Δt (At AC), which was stored the earliest, among the pairs of the time difference Δt and sender address stored in the buffer 80 is stored into the register 81 and is transmitted to the fire mechanism 11c.

Further, in the connection strength mechanism 8, the corresponding address in the connection strength memory 82 is specified on the basis of the sender address (represented by “Sender addr.”) of the pair stored the earliest in the buffer 80, and the connection strength W of the firing node 11A is read from the corresponding address. The read connection strength W is stored in the register 83 and transmitted to the fire mechanism 11c.

### (Step E28)

In Step E28, the firing node 11C generates a spike 5C. The spike 5C meets the spike 5A that is stored the earliest in the input buffer 11a (see reference sign F3). In addition, the time difference Δt_AC and sender address obtained in Step E27 are stored in the buffers 80 of the connection strength mechanism 8.

The W update circuit 84 (denoted as “W update”) calculates the updated connection strength W based on the time difference Δt and the connection strength W inputted from the registers 81 and 83, respectively, and updates the connection strength W of the address of the connection strength memory 82 corresponding to the sender address of the firing node 11A.

### (Step E29)

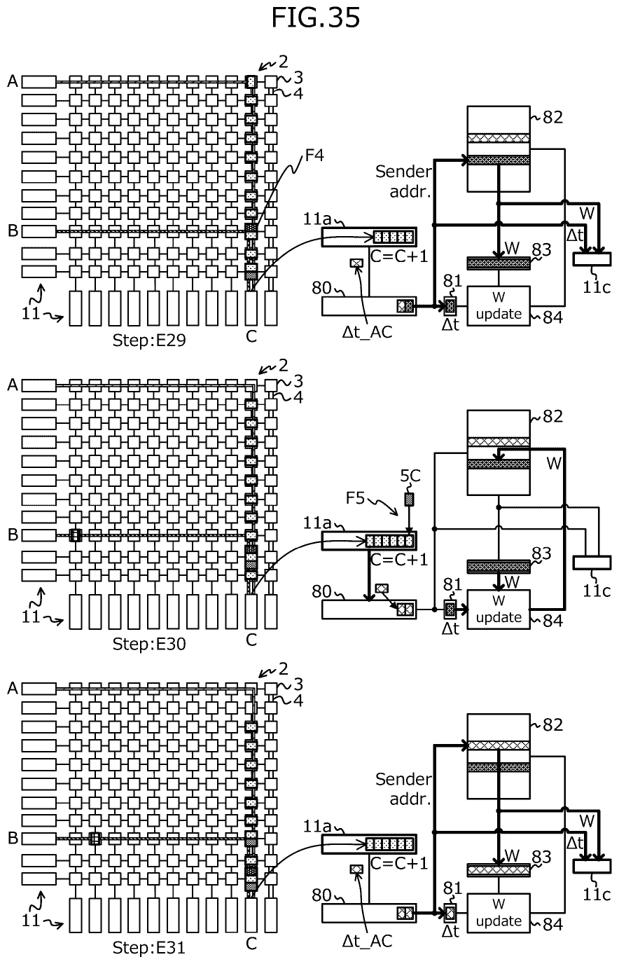

As illustrated in FIG. 35, in Step E29, the pre-spike 5B meets the post-spike 5C at the time-difference calculation circuit 3 in the time-difference calculation circuit array 2 (see reference sign F4). As a result of the meeting, the spike 5C is discarded and the time difference Δt_BC is set in the spike 5B. For example, if the sender address set in the pre-spike 5B matches the receiver address set the post-spike 5C (if the both addresses indicate the firing node 11B), the in time-difference calculation circuit 3 may discard the post-spike 5C. As the above, the post-spike 5 may be discarded when the sender address of the post-spike 5 matches the receiver address of the pre-spike 5 and also the receiver address of the post-spike 5 matches the sender address of the pre-spike 5 in the time-difference calculation circuit 3. The same applies in the in the following description.

In addition, the spike 5C generated in Step E28 is transmitted from the firing node 11C to the time-difference calculation circuit array 2.

The input buffer 11a obtains, due to the meeting of the spikes 5 in Step E28, the time difference Δt_AC between the spikes 5A and 5C and the sender address of the spike 5A.

In the connection strength mechanism 8, the time difference Δt (Δt_BC) of the pair, which was stored the earliest in the buffer 80, is stored into the register 81 and is transmitted to the fire mechanism 11c.

In addition, in the connection strength mechanism 8, the connection strength W of the firing node 11B is read from the connection strength memory 82 on the basis of the sender address of the pair stored the earliest in the buffer 80. The read connection strength W is stored in the register 83 and transmitted to the fire mechanism 11c.

### (Step E30)

In Step E30, the firing node 11C generates the spike 5C. The spike 5C meets the spike 5A that is stored the earliest in the input buffer 11a (see reference sign F5). In addition, the time difference Δt AC and sender address obtained in Step E29 are stored in the buffer 80 of the connection strength mechanism 8.

The W update circuit 84 calculates the updated connection strength W based on the time difference Δt and the connection strength W inputted from the registers 81 and 83, respectively, and updates the connection strength W of the address of the connection strength memory 82 corresponding to the sender address of the firing node 11B.

### (Step E31)

In step E31, the spike 5C generated in Step E30 is transmitted from the firing node 11C to the time-difference calculation circuit array 2. The input buffer 11a obtains, due to the meeting of the spikes 5 in Step E30, the time difference Δt AC between the spikes 5A and 5C and the sender address of the spike 5A.

In the connection strength mechanism 8, the time difference Δt (Δt_AC) of the pair, which was stored the earliest in the buffer 80, is stored into the register 81 and is transmitted to the fire mechanism 11c. In addition, in the connection strength mechanism 8, the connection strength W of the firing node 11A is read from the connection strength memory 82 based on the sender address of the pair stored the earliest in the buffer 80. The read connection strength W is stored in the register 83 and transmitted to the fire mechanism 11c.

### (Step E32)

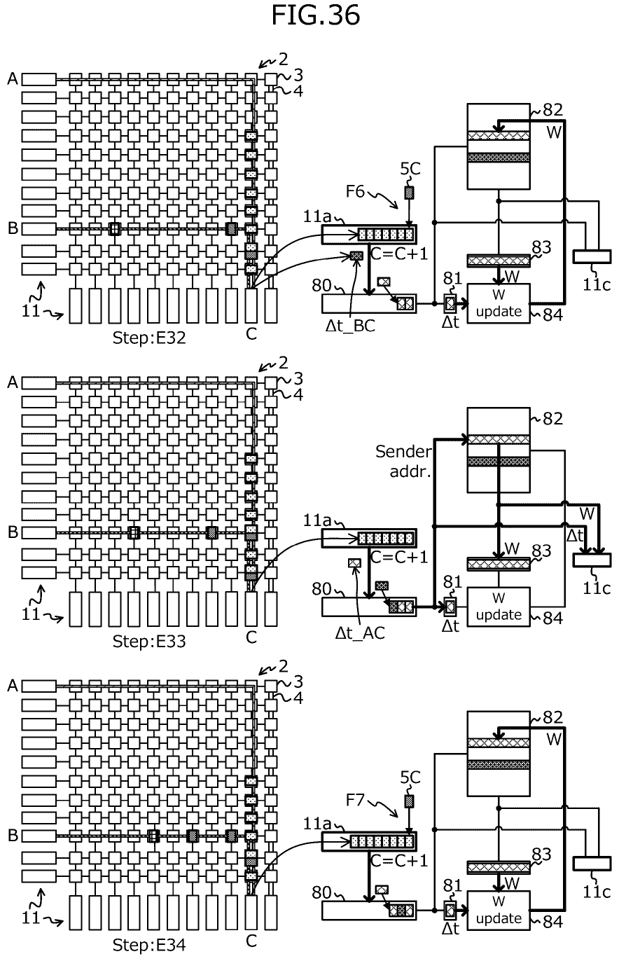

As illustrated in FIG. 36, in Step E32, the firing node 11C generates the spike 5C. The spike 5C meets the spike 5A that is stored the earliest in the input buffer 11a (see reference sign F6). In addition, the time difference Δt_AC and sender address obtained in Step E31 are stored in the buffers 80 of the connection strength mechanism 8.

In addition, the spike 5B met in the time-difference calculation circuit array 2 in Step E29 reaches the firing node 11C. The input buffer 11a obtains the time difference Δt_BC and the sender address included (set) in the spike 5B.

The W update circuit 84 calculates the updated connection strength W based on the time difference Δt and the connection strength W input from the registers 81 and 83, respectively, and updates the connection strength W of the address of the connection strength memory 82 corresponding to the sender address of the firing node 11A.

### (Step E33)

In Step E33, the input buffer 11a obtains, due to the meeting of the spikes 5 in Step E32, the time difference Δt_AC between the spikes 5A and 5C and the sender address of the spike 5A. In addition, the time difference Δt_BC and the sender address obtained in Step E32 are stored in the buffers 80 of the connection strength mechanism 8.

### (Steps E34 to E42)

As illustrated in FIG. 36 to FIG. 39, the process with the same logic as that of the above-described process is carried out in Steps E34 to E42. For example, in Steps E34, E36, E38, E40, and E42, the spike 5C is generated in the firing node 11C and meets the spike 5A (see the reference signs F7 and F9-F12). In the ensuing steps to these steps, the time difference Δt_AC and the sender address are obtained and also the spike 5C is transmitted to the time-difference calculation circuit array 2.

Further, for example, if the spike 5B meets the spike 5C in the time-difference calculation circuit array 2 (see Step E35: reference sign F8), the spike 5C is discarded and the spike 5B including the time difference Δt_BC is transmitted to the firing node 11C.

In firing node 11C, when the input buffer 11a obtains the time difference Δt (Δt_AC, Δt_BC) and the sender address, these data are stored in the buffer 80 in the ensuing step. In the further ensuing step, the time difference Δt is outputted from the buffer 80 to the register 81 and the fire mechanism 11c, and the connection strength W corresponding to the sender address is read from the connection strength memory 82 and outputted to the register 83 and the fire mechanism 11c. In the still further ensuing step, the W update circuit 84 updates the connection strength W of the connection strength memory 82 on the basis of the time difference Δt and the connection strength W read from registers 81 and 83, respectively.

The following description with respect to Steps E43 to E63 omits the description of the process by the same logic as the above-described process in the time-difference calculation circuit array 2 and the firing node 11C.

### (Step E43)

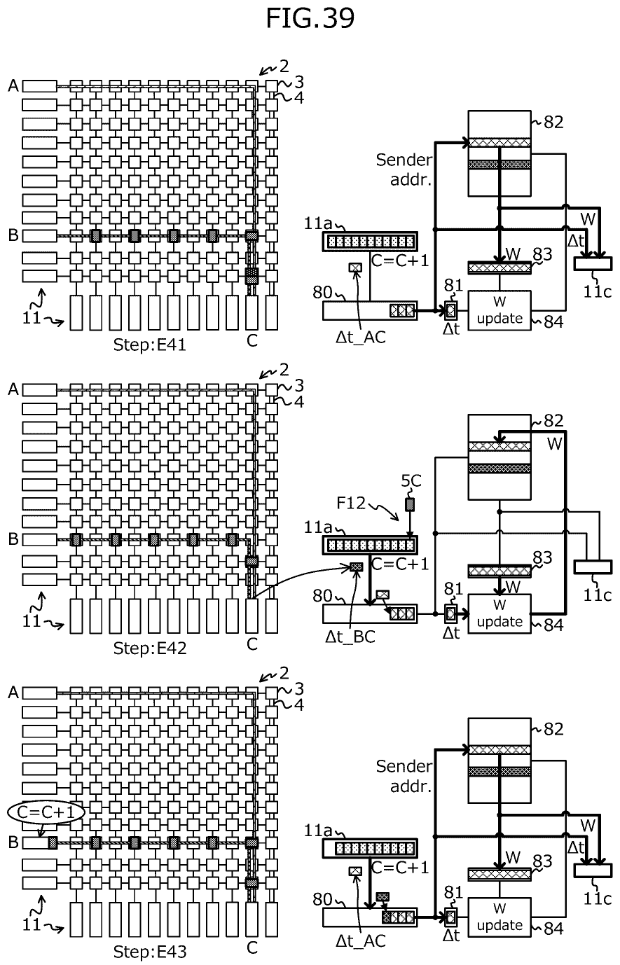

As illustrated in FIG. 39, the spike 5C reaches the firing node 11B in Step E43. Step E43 illustrates a state where the spike 5C is stored in the input buffer 11a of the firing node 11B. The value of the counter C of the spike 5C stored in the input buffer 11a of the firing node 11B is incremented by one in each step until the spike 5C stored in the input buffer 11a of the firing node 11B meets the spike 5B transmitted from the firing node 11B (expressed as “C=C+1”). The value of the counter C of the spike 5C in the firing node 11B is updated in the subsequent steps in the same manner.

### (Steps E44 to E46)

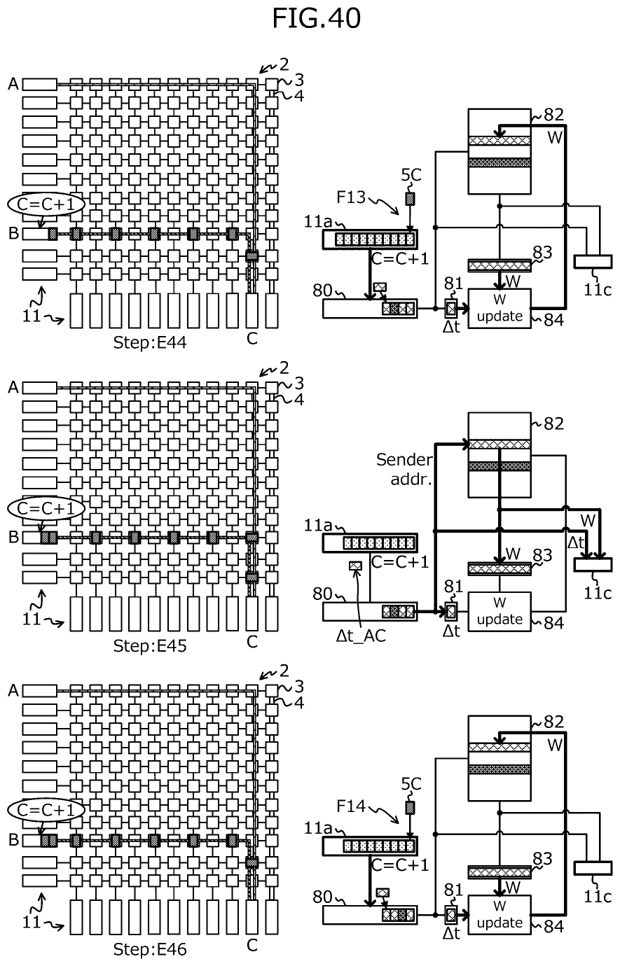

As illustrated in FIG. 40, in Step E44, the group of the spikes 5C proceeds by one hop toward the firing node 11B. In Step E45, the following spike 5C arrives at the firing node 11B. In Step E46, the group of the spikes 5C proceeds by one hop toward the firing node 11B.

### (Step E47)

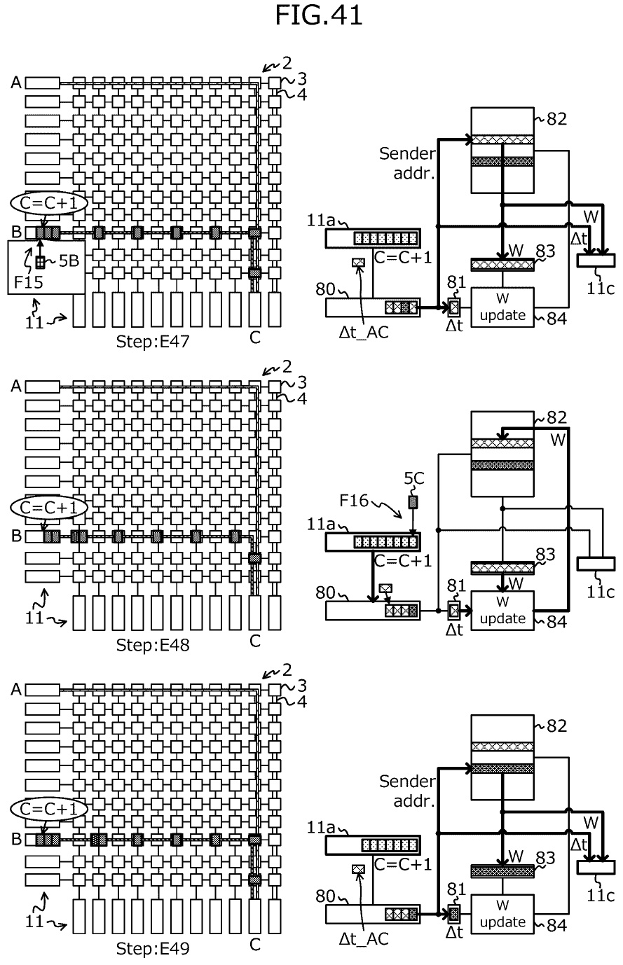

As illustrated in FIG. 41, in Step E47, the fire mechanism 11c of the firing node 11B generates a pre-spike 5B destined for the firing node 11C. The spike 5B meets the spike 5C stored the earliest among the spikes 5 stored in the input buffer 11a (see the reference sign F15). The spike 5C met the spike 5B is discarded. The time difference Δt_BC between the spikes 5B and 5C is calculated and set in the spike 5B.

### (Step E48)

In Step E48, the spike 5B in which the time difference Δt_BC is set in Step E47 is transmitted from the firing node 11B to the time-difference calculation circuit array 2.

### (Step E49 to E59)

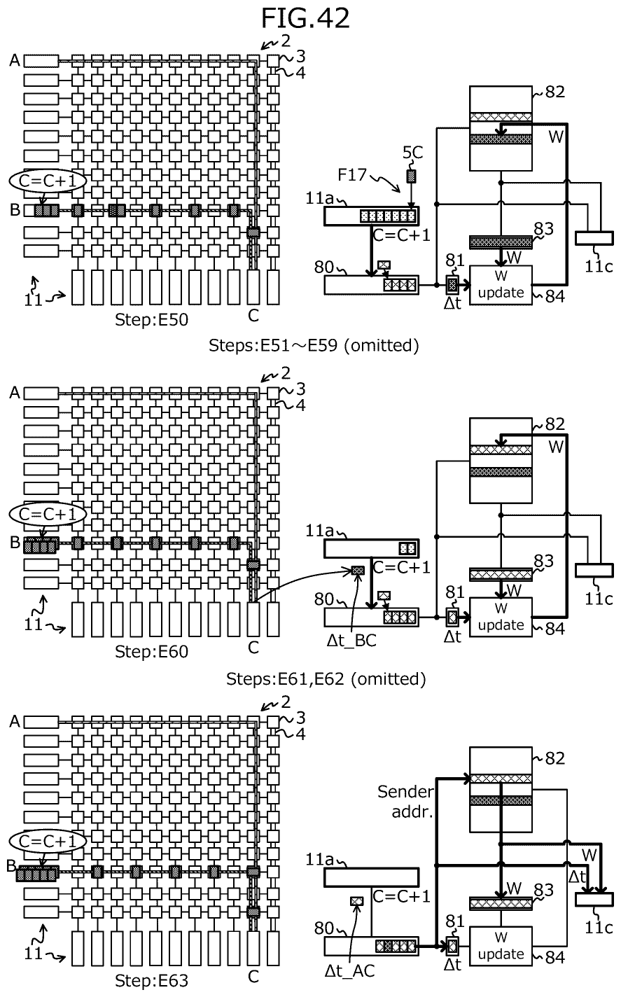

As illustrated in FIG. 41 and FIG. 42, in Steps E49 to E59 (illustration of Step E51 to E59 is omitted), the spike 5B transmitted in Step E48 propagates through the time-difference calculation circuit array 2 and reaches the time-difference calculation circuit 3 (router 4) immediately adjacent to the firing node 11C in Step E59.

### (Step E60)

In Step E60, the spike 5B transmitted in Step E48 reaches the firing node 11C, and the time difference Δt_BC and the sender address set in the spike 5B are obtained in the input buffer 11a.

### (Steps E61 to E63)

In Steps E61 to E63 (illustration of Steps E61 and E62 is omitted), the time-difference calculation circuit array 2 and the firing node 11C carry out the process with the same logic as that of the above-described process. In Step E63, the input buffer 11a of the firing node 11C is empty. On the other hand, in the firing node 11B, the spike 5B is not transmitted and the received spikes 5C are accumulated in the input buffer 11a.

### (F) Miscellaneous:

The technique described above can be changed and modified as follows.

For example, each of the initial values of the counters J and C set in a spike 5 according to the one embodiment are not limited to zero, and various values may be used as far as the values are commonly defined in the NC 1.

The order of storing spikes 5 in the input buffer 11a, the order of storing the time differences At in the buffer 80 illustrated in FIG. 32 to FIG. 42 are not limited to the order of receiving of the spikes 5 and may alternatively different from the order of receiving.

The hardware configuration of each of the firing nodes 11, the time-difference calculation circuits 3, and the routers 4 is not limited to the those illustrated in FIG. 14 to FIG. 18, FIG. 24, and FIG. 27 and may be appropriately modified and changed.

As one aspect, the one embodiment discussed as the above can improve the hardware scalability of neuromorphic computing.

Throughout the descriptions, the indefinite article “a” or “an”, or adjective “one” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A neuromorphic computing circuit comprising:
a plurality of nodes that generate a spike, the spike including a counter for an existing time of the spike and information indicating a sender of the spike, the plurality of nodes including a first node and a second node; and
a transmission array that forms a transmission path of the spike by connecting the plurality of nodes, wherein
the transmission array comprises a plurality of transmission circuits, one or more of the plurality of transmission circuits on the transmission path of the spike forwarding the spike,
each of the plurality of transmission circuits is configured to:
update a value of the counter when forwarding the spike,
set, when detecting meeting of a first spike transmitted from the first node to the second node and a second spike transmitted from the second node to the first node, a time difference calculated based on the values of the counters of the first spike and the second spike, into the first spike being forwarded, and
the second node comprises a spike generation circuit being configured to
specify one or more time differences equal or less than a first threshold among a plurality of time differences set in a plurality of spikes received from the transmission array,
accumulate connection strengths each between one of the sender nodes of third spikes set the specified time differences therein and the second node, and
generate a fourth spike when the result of the accumulating exceeds a second threshold.

2. The neuromorphic computing circuit according to claim 1, wherein
the spike generation circuit updates the first threshold based on a time interval between a generation timing of the fourth spike and a generation timing of a fifth spike generated immediately before the fourth spike, and based on the number of times of accumulating the connection strengths during the time interval.

3. The neuromorphic computing circuit according to claim 1, wherein
the spike generation circuit comprises
a buffer that stores, for each of the plurality of spikes received from the transmission array, the time difference set in the spike and the connection strength between the sender node of the spike and the second node in association with each other, and
an accumulator that, when the time difference read from the buffer is equal to or less than the first threshold, reads and accumulates the connection strength stored in the buffer in association with the read time difference.

4. The neuromorphic computing circuit according to claim 1, wherein
the second node further comprise a connection strength update circuit being configured to update, based on the time difference set in the first spike received from the transmission array, a first connection strength between the second node and the first node.

5. The neuromorphic computing circuit according to claim 4, wherein
the connection strength update circuit comprises
a memory that stores information indicating each of the plurality of nodes and a connection strength between the node and the second node in association with each other, and
an update circuit configured to
read, based on information indicating the sender included in the first spike received from the transmission array, a first connection strength from the memory, and
update, based on the time difference set in the first spike and the first connection strength read from the memory, the first connection strength stored in the memory.

6. The neuromorphic computing circuit according to claim 5, wherein
the connection strength update circuit transmits, to the spike generation circuit, the time difference set in the first spike and the first connection strength read from the memory.

7. The neuromorphic computing circuit according to claim 1, wherein
each of the plurality of transmission circuits and the plurality of nodes calculates the time difference by subtracting a value of the counter of the first spike from a value of the counter of the second spike.

8. The neuromorphic computing circuit according to claim 1, wherein
when detecting the meeting and calculating the time difference, each of the plurality of transmission circuits and the plurality of nodes discards the second spike.

9. The neuromorphic computing circuit according to claim 1, wherein
the transmission array arranges the plurality of transmission circuits in a two- or three-dimensional mesh shape and forms the transmission path according to the spike by routing in a dimensional order.

10. A method for controlling a neuromorphic computing circuit comprising a plurality of nodes that includes a first node and a second node, and a transmission array that connects the plurality of nodes to one another, the method comprising:
at each of the plurality of node, generating a spike, the spike including a counter for an existing time of the spike and information indicating a sender of the spike,
at each of a plurality of transmission circuits included in the transmission array, one or more of the plurality of the transmission circuits on the transmission path of the spike forwarding the spike,
updating a value of the counter when forwarding the spike,
setting, when detecting meeting of a first spike transmitted from the first node to the second node and a second spike transmitted from the second node to the first node, a time difference calculated based on the values of the counters of the first spike and the second spike, into the first spike being forwarded, and
at a spike generation circuit included in the second node
specifying one or more time differences equal or less than a first threshold among a plurality of time differences set in a plurality of spikes received from the transmission array,
accumulating connection strengths each between one of the sender nodes of third spikes set the specified time differences therein and the second node, and
generating a fourth spike when the result of the accumulating exceeds a second threshold.

11. The method according to claim 10, further comprising
at the spike generation circuit, updating the first threshold based on a time interval between a generation timing of the fourth spike and a generation timing of a fifth spike generated immediately before the fourth spike, and based on the number of times of accumulating the connection strengths during the time interval.

12. The method according to claim 10, further comprising:
at the spike generation circuit,
reading, for each of the plurality of spikes received from the transmission array, the time difference set in the spike, from a buffer that stores the time difference set in the spike and the connection strength between the sender node of the spike and the second node in association with each other, and
when the time difference read from the buffer is equal to or less than the first threshold, reading the connection strength stored in the buffer in association with the read time difference from the buffer and accumulating the read connection strength in an accumulator.

13. The method according to claim 10, further comprising
at a connection strength update circuit included in the second node,
updating, based on the time difference set in the first spike received from the transmission array, a first connection strength between the second node and the first node.

14. The method according to claim 13, further comprising
at the connection strength update circuit,
reading, based on information indicating the sender included in the first spike received from the transmission array, a first connection strength from a memory, the memory storing information indicating each of the plurality of nodes and a connection strength between the node and the second node in association with each other, and
updating, based on the time difference set in the first spike and the first connection strength read from the memory, the first connection strength stored in the memory.

15. The method according to claim 14, further comprising
at the connection strength update circuit, transmitting, to the spike generation circuit, the time difference set in the first spike and the first connection strength read from the memory.

16. The method according to claim 10, further comprising
at each of the plurality of transmission circuits and the plurality of nodes, calculating the time difference by subtracting a value of the counter of the first spike from a value of the counter of the second spike.

17. The method according to claim 10, further comprising
at each of the plurality of transmission circuits and the plurality of nodes, discarding the second spike when detecting the meeting and calculating the time difference.

18. The method according to claim 10, further comprising
at the transmission array, arranging the plurality of transmission circuits in a two- or three-dimensional mesh shape and forming the transmission path according to the spike by routing in a dimensional order.
